(19) United States
(12) Patent Application Publication
(10) Pub. No.: US 2023/0106790 A1
(43) Pub. Date: Apr. 6, 2023

(54) METHODS FOR CSI-RS TRANSMISSION

(71) Applicant: Telefonaktiebolaget LM Ericsson (publ), Stockholm (SE)

(72) Inventors: Mattias FRENNE, Uppsala (SE); George JÖNGREN, Sundbyberg (SE); Lars LINDBOM, Karlstad (SE); Karl WERNER, Segeltorp (SE)

(21) Appl. No.: 17/799,443

(22) PCT Filed: Feb. 12, 2021
(86) PCT No.: PCT/IB2021/051216

§ 371 Date: Aug. 12, 2022

Related U.S. Application Data
(60) Provisional application No. 62/976,849, filed on Feb. 14, 2020.

(51) Int. Cl. H04B 7/06; H04L 5/00; H04L 27/26

(52) U.S. Cl. CPC H04B 7/0626; H04L 5/0016; H04L 5/0051; H04L 27/2605; H04L 27/2613

(57) ABSTRACT

A method, system and apparatus are disclosed for channel state information reference signal (CSI-RS) transmission. In one embodiment, a wireless device (WD) is configured to receive a configuration of at least one CSI-RS resource. The configuration indicates at least one parameter for at least one modifier for the at least one CSI-RS resource, optionally: the at least one modifier being one of at least one multiplier sequence, at least one CSI-RS port to orthogonal cover code, OCC, index permutation sequence and at least one CSI-RS port to OCC index cyclic shifting; at least one of the at least one parameter being used as a seed to generate the at least one multiplier sequence; and/or at least one of the at least one parameter being at least one cyclic shift value for cyclic shifting of the at least one CSI-RS port.

### TECHNICAL FIELD

The present disclosure relates to wireless communications, and in particular, to methods and apparatuses for channel state information reference signal (CSI-RS) transmission.

### BACKGROUND

The new generation mobile wireless communication system (e.g., Third Generation Partnership Project (3GPP) 5^{th} Generation (5G), also called New Radio (NR)), supports a diverse set of use cases and a diverse set of deployment scenarios. The later includes deployment at both low frequencies (100s of MHz), similar to Long Term Evolution (LTE) today, and very high frequencies (millimetre (mm) waves in the tens of GHz). At high frequencies, propagation characteristics make achieving good coverage challenging. One solution to the coverage issue is to employ high-gain beamforming, typically in an analog manner, in order to achieve satisfactory link budget.

Note that terminology used here such as network node (e.g., gNB) and wireless device (WD) should be considered non-limiting and does in particular not imply a certain hierarchical relation between the two. In general, “network node (e.g., gNB)” could be considered as device 1 and “WD” as device 2, and these two devices communicate with each other over some radio channel. Alternatively, other terminology such as “gNodeB” can be used in place of “network node (e.g., gNB)” in different communication systems. Herein, we also focus on wireless transmissions in the downlink, but the techniques may be equally applicable in the uplink

NR uses orthogonal frequency division multiplexing (OFDM) in the downlink and uplink The basic NR downlink physical resource can thus be seen as a time-frequency grid as illustrated in FIG. 1, for example, where each resource element (RE) corresponds to one OFDM subcarrier during one OFDM symbol interval. Although a subcarrier spacing of Δf=15 kHz is shown in FIG. 1, different subcarrier spacing values are supported in NR. The supported subcarrier spacing values (also reference to as different numerologies) in NR are given by Δf=(15×2^{α}) kHz where a is a non-negative integer.

In the time domain, downlink transmissions are organized into radio frames of 10 milliseconds (ms), each radio frame including ten equally sized subframes of length T_{subframe}=1 ms which is shown in FIG. 2, for example. While a subframe is always 1 ms, in NR, a slot length for a (15×2^{α}) kHz subcarrier spacing is y ½^{α} ms.

Furthermore, the resource allocation is typically described in terms of resource blocks (RB), where a resource block corresponds to one slot (14 OFDM symbols) in the time domain and 12 contiguous subcarriers in the frequency domain Resource blocks are numbered in the frequency domain, starting with 0 from one end of the bandwidth part (BP).

Downlink transmissions are dynamically scheduled, i.e., in each subframe the network node (e.g., gNB) transmits control information about to which terminals data is transmitted and upon which resource blocks the data is transmitted, in the current downlink subframe. This control signaling is typically transmitted in the first 1, 2, 3 or 4 OFDM symbols in each slot in NR.

### Codebook-Based Precoding

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

A core component in NR is the support of MIMO antenna deployments and MIMO related techniques including beamforming at higher carrier frequencies. Currently LTE and NR support an 8-layer spatial multiplexing mode to a single WD for up to 32 Tx antennas with channel dependent precoding. The spatial multiplexing mode is aimed for high data rates in favorable channel conditions. An illustration of the spatial multiplexing operation is provided in FIG. 3, for example.

As seen, the information carrying symbol vector s is multiplied by an N_{T}×r precoder matrix W, which serves to distribute the transmit energy in a subspace of the NT (corresponding to N_{T} antenna ports) dimensional vector space. The precoder matrix is typically selected from a codebook of possible precoder matrices, and typically indicated by means of a precoder matrix indicator (PMI), which specifies a unique precoder matrix in the codebook for a given number of symbol streams. The r symbols in s each correspond to a layer and r is referred to as the transmission rank. In this way, spatial multiplexing is achieved since multiple symbols can be transmitted simultaneously over the same time/frequency resource element (TFRE). The number of symbols r is typically adapted to suit the current channel properties.

NR uses OFDM in the downlink and hence the received N_{R}×1 vector yₙ for a certain TFRE on subcarrier n (or alternatively data TFRE number n) is thus modelled by

yₙ=HₙWsₙ+eₙ
where eₙ is a noise/interference vector obtained as realizations of a random process. The precoder, W, can be a wideband precoder, which is constant over frequency, or frequency selective.

The precoder matrix is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to the WD. In addition, the precoder matrix may also be selected to strive for orthogonalizing the channel, meaning that after proper linear equalization at the WD, the inter-layer interference is reduced.

The transmission rank, and thus the number of spatially multiplexed layers, is reflected in the number of columns of the precoder. For efficient performance, it may be useful that a transmission rank that matches the channel properties is selected.

### Codebook Based Channel State Information (CSI) Estimation and Feedback

In NR, closed loop MIMO transmission schemes is used where the WD estimates and feeds back the downlink CSI to the network node (e.g., gNB). The network node (e.g., gNB) uses the feedback CSI to transmit downlink data to the WD. The CSI includes at least one of a transmission rank indicator (RI), a precoding matrix indicator (PMI) and a channel quality indicator(s) (CQI). A codebook of precoding matrices is used by the WD to find out the best match between the estimated downlink channel Hₙ, and a precoding matrix in the codebook based on certain criteria, for example, the WD throughput. The channel Hₙ, is estimated based on a Non-Zero Power CSI reference signal (NZP CSI-RS) transmitted in the downlink

The CQI/RI/PMI together provide the downlink channel state to the WD. This is also referred to as implicit CSI feedback since the estimation of Hₙ is not fed back directly. The CQI/RI/PMI can be wideband or subband depending on which reporting mode is configured.

The RI corresponds to a recommended number of streams that are to be spatially multiplexed and thus transmitted in parallel over the downlink channel. The PMI identifies a recommended precoding matrix codeword (in a codebook which contains precoders with the same number of rows as the number of CSI-RS ports) for the transmission, which relates to the spatial characteristics of the channel. The CQI represents a recommended transport block size (i.e., code rate) and LNR supports transmission of one or two simultaneous (on different layers) transmissions of transport blocks (i.e., separately encoded blocks of information) to a WD in a subframe. There is thus a relation between a CQI and an SINR of the spatial stream(s) over which the transport block (TB) or blocks are transmitted.

Codebooks of up to 32 antenna ports have been defined in NR. Both one dimensional (1D) and two-dimensional (2D) antenna arrays are supported. The codebook is designed with a specific antenna numbering (or rather port numbering scheme, where the mapping of antenna port to physical antenna is up to each deployment).

For a given P antenna ports, the precoding codebooks are designed so that the P/2 first antenna ports (e.g., port number 15, 16, 17, 18) maps to a set of co-polarized antennas and the P/2 last antenna ports (e.g., 19, 20, 21, 22) are mapped to another set of co-polarized antennas, with an orthogonal polarization to the first set. This is thus targeting cross-polarized antenna arrays. See FIG. 4 for an example of the case of 8 antenna ports.

Hence, the codebook principles for the rank 1 case are that a DFT “beam” vector is chosen for each set of P/2 ports and a phase shift with a quadrature phase-shift keying (QPSK) alphabet is used to co-phase the two sets of antenna ports. A rank 1 codebook is thus constructed as,

$$( \begin{matrix}a \\ {ae}^{i ω}\end{matrix} )$$

Where a is a length P/2 vector that forms a beam for the first and second polarizations respectively, and co is a co-phasing scalar that co-phases the two orthogonal polarizations.

### Channel State Information Reference Symbols (CSI-RS)

In NR, a reference symbol sequence is introduced for the intent to estimate channel state information, the CSI-RS. By measuring on a CSI-RS a WD can estimate the effective channel the CSI-RS is traversing including the radio propagation channel and antenna gains. In more mathematical rigor this may imply that if a known CSI-RS signal X is transmitted, a WD can estimate the coupling between the transmitted signal and the received signal (i.e., the effective channel). Hence, if no virtualization is performed in the transmission, the received signal y can be expressed as,

y=Hx+e

and the WD can estimate the effective channel H . Up to 32 CSI-RS ports can be configured for a NR WD. That is, the WD can estimate the channel from up to thirty-two transmit antenna ports.

An antenna port can be considered equivalent to a reference signal resource that the WD uses to measure the channel. Hence, a network node (e.g., gNB) with two antennas could define two CSI-RS ports, where each port is a set of resource elements in the time frequency grid within a subframe or slot. The base station transmits each of these two reference signals from each of the two antennas so that the WD can measure the two radio channels and report channel state information back to the base station based on these measurements. In NR, CSI-RS resources with 1, 2, 4, 8, 12, 16, 24 and 32 ports are supported.

The sequence used for CSI-RS is r(m) and is defined by

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where the pseudo-random sequence c(i) is defined in clause 5.2.1 of 3GPP Technical Specification (TS) 38.211. The pseudo-random sequence generator may be initialised with

cᵢₙᵢₜ=(2¹⁰(N_{symb}^{slot}n_{s,f}^{μ}+l+1)(2n_{ID}+1)+n_{ID})mod 2³¹

at the start of each OFDM symbol where n_{s,f}^{μ} is the slot number within a radio frame, l is the OFDM symbol number within a slot, and n_{ID} equals the higher-layer parameter scramblingID or sequenceGenerationConfig.

There are 18 different CSI-RS resource configurations in NR, where each have a specific number of ports X. See Table 1 below, for example. When code division multiplexing/code domain sharing (CDM) is applied, the index kᵢ indicates the first subcarrier in the physical resource block (PRB) that is used for mapping the CSI-RS sequence to resource elements, where the second subcarrier is kᵢ+1. This set (kᵢ, kᵢ+1) of two subcarriers is associated with a CDM group j, where a CDM group covers 1, 2 or 4 OFDM symbols. The index l_{i′}, or l_{i′}+1, indicates the first OFDM symbol within the slot that is associated with a CDM group. Note that kᵢ and l_{i′} are parameters signalled from network node (e.g., gNB) to WD by radio resource control (RRC) signalling when configuring the CSI-RS resource.

When CDM is applied, the size of a CDM group, L, is either 2, 4 or 8 and the total number of CDM groups is given by the number of (kᵢ, l_{i′}), (kᵢ, l_{i′}, +1) pairs given by the configuration. A CDM group can thus refer to a set of 2, 4 or 8 antenna ports, where the set of 2 antenna ports occurs when only CDM in frequency-domain over two adjacent subcarriers is considered (FD-CDM2).

In NR, CSI-RS ports are numbered within a CDM group first and then across CDM groups j, such as:

p=3000+p′, where p′=s+j ·L with s=0, 1, . . . , L−1.

Ports are sometimes numbered by excluding the value “3000”, meaning that ports are implicitly indicated by p′. For example, CSI-RS resource configuration given by row 4 in Table 1 has two CDM groups (j=0, 1) of size L=2, where the ports 3000 and 3001 maps to the CDM group indicated by k₀, and the ports 3002 and 3003 maps to the CDM group indicated by k₀+2.

TABLE 1
CSI-RS resource configurations

| | | | | | CDM | | |
|---|---|---|---|---|---|---|---|
| | Ports | Density | | | group | | |
| Row | X | P | cdm-Type | (k̅, l̅) | index j | k′ | l′ |
| 1 | 1 | 3 | noCDM | (k₀, l₀), (k₀ + 4, l₀), (k₀ + 8, l₀) | 0, 0, 0 | 0 | 0 |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), (k₃, l₀) | 0, 1, 2, 3 | 0, 1 | 0 |
| 7 | 8 | 1 | fd-CDM2 | (k₀, l₀), (k₁, l₀), k₀, l₀ + 1), | 0, 1, 2, 3 | 0, 1 | 0 |
| | | | | (k₁, l₀ + 1) | | | |
| 8 | 8 | 1 | cdm4- | (k₀, l₀), (k₁, l₀) | 0, 1 | 0, 1 | 0, 1 |
| | | | FD2-TD2 | | | | |
| 9 | 12 | 1 | fd-CDM2 | k₀, l₀), k₁, l₀), (k₂, l₀), | 0, 1, 2, 3, | 0, 1 | 0 |
| | | | | (k₃, l₀), (k₄, l₀), (k₅, l₀) | 4, 5 | | |
| 10 | 12 | 1 | cdm4- | (k₀, l₀), (k₁, 1₀), (k₂, l₀) | 0, 1, 2 | 0, 1 | 0, 1 |
| | | | FD2-TD2 | | | | |
| 11 | 16 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + l), (k₁, l₀ + 1), | 4, 5, 6, 7 | | |
| | | | | (k₂, l₀ + 1), (k₃, l₀ + 1) | | | |
| 12 | 16 | 1, 0.5 | cdm4- | (k₀, l₀), (k₁, l₀), (k₂, l₀), (k₃, l₀) | 0, 1, 2, 3 | 0, 1 | 0, 1 |
| | | | FD2-TD2 | | | | |
| 13 | 24 | 1, 0.5 | fd-CDM2 | (k₀, l₀), (k₁, l₀), (k₂, l₀), (k₀, l₀ + 1), | 0, 1, 2, 3, | 0, 1 | 0 |
| | | | | (k₁, l₀ + 1), (k₂, l₀ +1), (k₀, l₁), | 4, 5, 6, 7, | | |
| | | | | (k₁, l₁), (k₂, l₁ +1), (k₁, l₁ + 1), | 8, 9, 10, | | |
| | | | | (k₂, l₁ + 1) | 11 | | |
| 14 | 24 | 1, 0.5 | cdm4- | (k₀, l₀), (k₁, l₀), (k₂, l₀), (k₀, l₁), | 0, 1, 2, 3, | 0, 1 | 0, 1 |
| | | | FD2-TD2 | (k₁, l₁), (k₂, l₁) | 4, 5 | | |
| 15 | 24 | 1, 0.5 | cdm8- | (k₀, l₀), (k₁, l₀), (k₂, l₀) | 0, 1, 2 | 0, 1 | 0, 1, |
| | | | FD2-TD4 | | | | 2, 3 |
| 16 | 32 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀, + 1), (k₁, l₀ + 1), | 4, 5, 6, 7, | | |
| | | | | (k₂, l₀ + 1 ), (k₃, l₀ + 1), (k₀, l₁), | 8, 9, 10, | | |
| | | | | (k₁, l₁), (k₂, l₁), (k₃, l₁), (k₀, l₁ + 1), | 11, 12, 13 | | |
| | | | | (k₁, l₁ + 1), (k₂, l₁ + 1), (k₃, l₁ + 1) | 14, 15 | | |
| 17 | 32 | 1, 0.5 | cdm4- | (k₀,l₀), (k1,l0), (k₂, l₀), (k₃,l₀), | 0, 1, 2, 3, | 0, 1 | 0, 1 |
| | | | FD2-TD2 | (k₀, l₁), (k₁, l₁), (k₂, l₁), (k₃, l₁) | 4, 5, 6, 7 | | |
| 18 | 32 | 1, 0.5 | cdm8- | (k₀, l₁), (k₁, l₁), (k₂, l₁), (k₃, l₁) | 0, 1, 2, 3 | 0, 1 | 0, 1, |
| | | | FD2-TD4 | | | | 2, 3 |

### Mapping of CSI-RS Ports to Resource Elements

The 3GPP specifications for NR, TS 38.211 version 16.0.0 states that for each CSI-RS configured, the WD is to assume the sequence r(m) being mapped to resources elements (k,l)_{p,μ} according to,

$${a}_{k , l}^{( p , μ )} = {β}_{C S I R S} {w}_{f} ( {k}^{′} ) \cdot {w}_{t} ( {l}^{′} ) \cdot {r}_{l , {n}_{s , f}} ( {m}^{′} )$$

$${m}^{′} = ⌊ n α ⌋ + {k}^{′} + ⌊ \frac{\overline{k} ρ}{{N}_{s c}^{R B}} ⌋$$

$$k = n {N}_{s c}^{R B} + \overline{k} + {k}^{′}$$

$$l = \overline{l} + {l}^{′}$$

$$α = \{ \begin{matrix}ρ & for X = 1 \\ 2 ρ & for X > 1\end{matrix}$$

$$n = 0 , 1 , …$$

when the following conditions are fulfilled: the resource element (k,l)_{p,μ} is within the resource blocks occupied by the CSI-RS resource for which the WD is configured.

From this expression, it is possible to deduce (when CDM is applied) that for a given CSI-RS resource (row in Table 1) within a given OFDM symbol (fixed 1), an antenna port p is mapped to two adjacent subcarriers using two samples from the sequence r(m′) where two adjacent values of m′ is used since m′ depends on k′=0, 1. The values of k̅, ρ and X are given by RRC configuration, and the parameters w_{f}(k′) and wₜ(l′) are given by Table 2 below, where the table index is related to port number as (3000+p) modulus L. For a CDM group of size L=2,4,8, the corresponding values on l′ are l′=0, 1′=0, 1,l′=0, 1, 2, 3.

TABLE 2
Orthogonal cover code (OCC) parameters.

| Index | [w_{f}(0) w_{f}(1)] | [wₜ(0) wₜ(1) wₜ(2) wₜ(3)] |
|---|---|---|
| 0 | [+1 +1] | [+1 +1 +1 +1] |
| 1 | [+1 −1] | [+1 +1 +1 +1] |
| 2 | [+1 +1] | [+1 −1 +1 −1] |
| 3 | [+1 −1] | [+1 −1 +1 −1] |
| 4 | [+1 +1] | [+1 +1 −1 −1] |
| 5 | [+1 −1] | [+1 +1 −1 −1] |
| 6 | [+1 +1] | [+1 −1 −1 +1] |
| 7 | [+1 −1] | [+1 −1 −1 +1] |

From this expression, it can also be observed that the mapping to resource elements do not depend on the CDM group. In other words, the same pseudo-random sequence is used in all the used CDM groups in OFDM symbol l.

This is illustrated by FIG. 5, for example, where the four ports p0=3000 to p3=3003 are mapped to two CDM groups (L=2) and where the same sequence samples r(0) and r(1) are used in both CDM groups. FIG. 5 may be considered to represent a CSI-RS resource configuration given by row 4 in Table 1, with the first CDM group starting at subcarrier k₀and the second starting at subcarrier k₀+2 (=k₁), both in the same OFDM symbol 1₀.

### SUMMARY

Some embodiments advantageously provide methods, systems, and apparatuses for channel state information reference signal (CSI-RS) transmission

In one embodiment, a method implemented in a network node includes configuring, a wireless device (WD), with at least one channel state information reference signal (CSI-RS) resource, the configuration indicating at least one multiplier sequence for the at least one CSI-RS resource; optionally, transmitting CSI-RS signaling on the at least one CSI-RS resource according to the configuration; and/or optionally, receiving CSI feedback based at least in part on the transmitted CSI-RS signaling.

In one embodiment, a method implemented in a WD includes receiving a configuration of at least one CSI-RS resource, the configuration indicating at least one multiplier sequence for the at least one CSI-RS resource; optionally, receiving CSI-RS signaling on the at least one CSI-RS resource according to the configuration; and/or optionally, performing a measurement on the received CSI-RS signaling and/or transmitting CSI feedback, the CSI feedback based at least in part on the measurement on the received CSI-RS signaling.

According to an aspect of the present disclosure, a method implemented in a wireless device, WD, is provided. The method comprises receiving a configuration of at least one channel state information reference signal, CSI-RS, resource, the configuration indicating at least one parameter for at least one modifier for the at least one CSI-RS resource, optionally, the at least one modifier being one of at least one multiplier sequence, at least one CSI-RS port to orthogonal cover code, OCC, index permutation sequence and at least one CSI-RS port to OCC index cyclic shifting; optionally, the configuration indicating a plurality of parameters for a plurality of modifiers; optionally, at least one of the at least one parameter being used as a seed to generate the at least one multiplier sequence; and optionally, at least one of the at least one parameter being at least one cyclic shift value for cyclic shifting of the at least one CSI-RS port. The method comprises optionally, receiving a CSI-RS signaling on the at least one CSI-RS resource according to the configuration. The method comprises optionally, performing a measurement on the received CSI-RS signaling and/or transmitting a CSI feedback, the CSI feedback based at least in part on the measurement on the received CSI-RS signaling.

In some embodiments, the at least one multiplier sequence comprises at least one port-specific multiplier sequence. In some embodiments, the at least one port-specific multiplier sequence comprises at least one port-specific multiplier sequence that is different for each antenna port of a code division multiplexing, CDM, group. In some embodiments, receiving the configuration comprises receiving the configuration via radio resource control, RRC, signaling. In some embodiments, at least one of the at least one multiplier sequence is based at least in part on at least one of a resource block index, n, the resource block index indicating a resource block on which the CSI-RS signaling is transmitted.

In some embodiments, each of the at least one multiplier sequence varies across a plurality of resource blocks, RBs. In some embodiments, at least one of the at least one multiplier sequence is based at least in part on a code division multiplexing, CDM, group index, s, the CDM group index indicating an orthogonal cover code. In some embodiments, for at least one antenna port in the configuration, a CSI-RS resource is configured with a reference signal sequence that is not based on the at least one multiplier sequence, while, for at least one other antenna port in the configuration, a CSI-RS resource is configured with a reference signal sequence that is based on the at least one multiplier sequence. In some embodiments, at least one of a reference signal sequence and at least one of the at least one multiplier sequence is a pseudo-random sequence, the pseudo-random sequence being a Gold sequence. In some embodiments, for at least one antenna port in the configuration, a reference signal sequence is configured to be generated by a pseudo-random sequence generator multiplied by at least one of the at least one multiplier sequence.

According to an aspect of the present disclosure, a method implemented in a network node is provided. The method comprises transmitting a configuration of at least one channel state information reference signal, CSI-RS, resource, the configuration indicating at least one parameter for at least one modifier for the at least one CSI-RS resource, optionally, the at least one modifier being one of at least one multiplier sequence, at least one CSI-RS port to orthogonal cover code, OCC, index permutation sequence and at least one CSI-RS port to OCC index cyclic shifting; optionally, the configuration indicating a plurality of parameters for a plurality of modifiers; optionally, at least one of the at least one parameter being used as a seed to generate the at least one multiplier sequence; and optionally, at least one of the at least one parameter being at least one cyclic shift value for cyclic shifting of the at least one CSI-RS port. The method comprises optionally, transmitting a CSI-RS signaling on the at least one CSI-RS resource according to the configuration. The method comprises optionally, receiving a CSI feedback based at least in part on the transmitted CSI-RS signaling.

In some embodiments, the at least one multiplier sequence comprises at least one port-specific multiplier sequence. In some embodiments, the at least one port-specific multiplier sequence comprises at least one port-specific multiplier sequence that is different for each antenna port of a code division multiplexing, CDM, group. In some embodiments, transmitting the configuration comprises transmitting the configuration via radio resource control, RRC, signaling. In some embodiments, at least one of the at least one multiplier sequence is based at least in part on at least one of a resource block index, n, the resource block index indicating a resource block on which the CSI-RS signaling is transmitted.

In some embodiments, each of the at least one multiplier sequence varies across a plurality of resource blocks, RBs. In some embodiments, at least one of the at least one multiplier sequence is based at least in part on a code division multiplexing, CDM, group index, s, the CDM group index indicating an orthogonal cover code. In some embodiments, for at least one antenna port in the configuration, a CSI-RS resource is configured with a reference signal sequence that is not based on the at least one multiplier sequence, while, for at least one other antenna port in the configuration, a CSI-RS resource is configured with a reference signal sequence that is based on the at least one multiplier sequence. In some embodiments, at least one of a reference signal sequence and at least one of the at least one multiplier sequence is a pseudo-random sequence, the pseudo-random sequence being a Gold sequence. In some embodiments, for at least one antenna port in the configuration, a reference signal sequence is configured to be generated by a pseudo-random sequence generator multiplied by at least one of the at least one multiplier sequence.

According to an aspect of the present disclosure, a wireless device, WD, configured to communicate with a network node is provided. The WD comprises processing circuitry. The processing circuitry is configured to cause the WD to receive a configuration of at least one channel state information reference signal, CSI-RS, resource, the configuration indicating at least one parameter for at least one modifier for the at least one CSI-RS resource, optionally, the at least one modifier being one of at least one multiplier sequence, at least one CSI-RS port to orthogonal cover code, OCC, index permutation sequence and at least one CSI-RS port to OCC index cyclic shifting; optionally, the configuration indicating a plurality of parameters for a plurality of modifiers; optionally, at least one of the at least one parameter being used as a seed to generate the at least one multiplier sequence; and optionally, at least one of the at least one parameter being at least one cyclic shift value for cyclic shifting of the at least one CSI-RS port; optionally, receive a CSI-RS signaling on the at least one CSI-RS resource according to the configuration; and/or optionally, perform a measurement on the received CSI-RS signaling and/or transmitting a CSI feedback, the CSI feedback based at least in part on the measurement on the received CSI-RS signaling.

In some embodiments, the at least one multiplier sequence comprises at least one port-specific multiplier sequence. In some embodiments, the at least one port-specific multiplier sequence comprises at least one port-specific multiplier sequence that is different for each antenna port of a code division multiplexing, CDM, group. In some embodiments, the processing circuitry is further configured to cause the WD to receive the configuration via radio resource control, RRC, signaling. In some embodiments, at least one of the at least one multiplier sequence is based at least in part on at least one of a resource block index, n, the resource block index indicating a resource block on which the CSI-RS signaling is transmitted.

In some embodiments, each of the at least one multiplier sequence varies across a plurality of resource blocks, RBs. In some embodiments, at least one of the at least one multiplier sequence is based at least in part on a code division multiplexing, CDM, group index, s, the CDM group index indicating an orthogonal cover code. In some embodiments, for at least one antenna port in the configuration, a CSI-RS resource is configured with a reference signal sequence that is not based on the at least one multiplier sequence, while, for at least one other antenna port in the configuration, a CSI-RS resource is configured with a reference signal sequence that is based on the at least one multiplier sequence. In some embodiments, at least one of a reference signal sequence and at least one of the at least one multiplier sequence is a pseudo-random sequence, the pseudo-random sequence being a Gold sequence. In some embodiments, for at least one antenna port in the configuration, a reference signal sequence is configured to be generated by a pseudo-random sequence generator multiplied by at least one of the at least one multiplier sequence.

According to an aspect of the present disclosure, a network node configured to communicate with a wireless device, WD, is provided. The network node comprises processing circuitry. The processing circuitry is configured to cause the network node to: transmit a configuration of at least one channel state information reference signal, CSI-RS, resource, the configuration indicating at least one parameter for at least one modifier for the at least one CSI-RS resource, optionally, the at least one modifier being one of at least one multiplier sequence, at least one CSI-RS port to orthogonal cover code, OCC, index permutation sequence and at least one CSI-RS port to OCC index cyclic shifting; optionally, the configuration indicating a plurality of parameters for a plurality of modifiers; optionally, at least one of the at least one parameter being used as a seed to generate the at least one multiplier sequence; and optionally, at least one of the at least one parameter being at least one cyclic shift value for cyclic shifting of the at least one CSI-RS port; optionally, transmit a CSI-RS signaling on the at least one CSI-RS resource according to the configuration; and/or optionally, receive a CSI feedback based at least in part on the transmitted CSI-RS signaling.

In some embodiments, the at least one multiplier sequence comprises at least one port-specific multiplier sequence. In some embodiments, the at least one port-specific multiplier sequence comprises at least one port-specific multiplier sequence that is different for each antenna port of a code division multiplexing, CDM, group. In some embodiments, the processing circuitry is further configured to cause the network node to transmit the configuration via radio resource control, RRC, signaling. In some embodiments, at least one of the at least one multiplier sequence is based at least in part on at least one of a resource block index, n, the resource block index indicating a resource block on which the CSI-RS signaling is transmitted.

In some embodiments, each of the at least one multiplier sequence varies across a plurality of resource blocks, RBs. In some embodiments, at least one of the at least one multiplier sequence is based at least in part on a code division multiplexing, CDM, group index, s, the CDM group index indicating an orthogonal cover code. In some embodiments, for at least one antenna port in the configuration, a CSI-RS resource is configured with a reference signal sequence that is not based on the at least one multiplier sequence, while, for at least one other antenna port in the configuration, a CSI-RS resource is configured with a reference signal sequence that is based on the at least one multiplier sequence. In some embodiments, at least one of a reference signal sequence and at least one of the at least one multiplier sequence is a pseudo-random sequence, the pseudo-random sequence being a Gold sequence. In some embodiments, for at least one antenna port in the configuration, a reference signal sequence is configured to be generated by a pseudo-random sequence generator multiplied by at least one of the at least one multiplier sequence.

According to an aspect of the present disclosure, an apparatus comprising computer program instructions executable by at least one processor to perform any one or more of the method above is provided.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of the LTE and NR downlink physical resource;

FIG. 2 illustrates an example of NR time-domain structure;

FIG. 3 illustrates an example transmission structure of precoded spatial multiplexing mode in NR;

FIG. 4 illustrates an example of port numbering of 8 antenna ports (here LTE port numbering is shown (15, 16, 17, . . . ) while for NR, the CSI-RS port numbering starts at 3000, i.e., (3000, 3001, . . . ));

FIG. 5 illustrates an example of Release 15 sequence mapped to CDM groups with corresponding CSI-RS antenna ports;

FIG. 6 illustrates an example of PMI selection frequency as a function of signal to interference ratio (SIR) for a setup with one WD and two cells (two network nodes (e.g., gNB));

FIG. 7 illustrates an example of PMI selection frequency as a function of signal to interference ratio (SIR) for a setup with one WD and two cells (two network nodes) when using at least one of the principles of the present disclosure;

FIG. 8 is a schematic diagram of an exemplary network architecture illustrating a communication system connected via an intermediate network to a host computer according to the principles in the present disclosure;

FIG. 9 is a block diagram of a host computer communicating via a network node with a wireless device over an at least partially wireless connection according to some embodiments of the present disclosure;

FIG. 10 is a flowchart illustrating exemplary methods implemented in a communication system including a host computer, a network node and a wireless device for executing a client application at a wireless device according to some embodiments of the present disclosure;

FIG. 11 is a flowchart illustrating exemplary methods implemented in a communication system including a host computer, a network node and a wireless device for receiving user data at a wireless device according to some embodiments of the present disclosure;

FIG. 12 is a flowchart illustrating exemplary methods implemented in a communication system including a host computer, a network node and a wireless device for receiving user data from the wireless device at a host computer according to some embodiments of the present disclosure;

FIG. 13 is a flowchart illustrating exemplary methods implemented in a communication system including a host computer, a network node and a wireless device for receiving user data at a host computer according to some embodiments of the present disclosure;

FIG. 14 is a flowchart of an exemplary process in a network node for sequencer unit according to some embodiments of the present disclosure;

FIG. 15 is a flowchart of an exemplary process in a wireless device for CSI feedback unit according to some embodiments of the present disclosure;

FIG. 16 is a flowchart of another exemplary process in a network node for sequencer unit according to some embodiments of the present disclosure;

FIG. 17 is a flowchart of another exemplary process in a wireless device for CSI feedback unit according to some embodiments of the present disclosure;

FIG. 18 illustrates an example of NR CSI-RS resource mapping with row=4 in Table 1 according to some embodiments of the present disclosure;

FIG. 19 illustrates an example of one embodiment to solve the false PMI problem according to some embodiments of the present disclosure;

FIG. 20 illustrates an example of an alternative embodiment where the first port does not have the multiplier sequence according to some embodiments of the present disclosure;

FIG. 21 illustrates an example of yet another embodiment where a different reference signal sequence is used for CDM group 1 compared to CDM group 0 and where the multiplier sequence depends on the orthogonal cover code index s, so y^{s}(n), s=0, 1, . . . , L−1, is used for all CDM groups (here, y⁰(n)=1) according to some embodiments of the present disclosure;

FIG. 22 illustrates an example of yet another embodiment where a different sequence is used for CDM group 1 compared to CDM group 0 but different multiplier sequences y^{p′}(n) is used for all ports p (here, y^{p′}(n)=1 is used for first port within a CDM group) according to some embodiments of the present disclosure;

FIG. 23 illustrates an example of an OFDM grid of subcarriers and OFDM symbols according to some embodiments of the present disclosure;

FIG. 24 illustrates an example of RB and CDM group dependent association between CSI-RS port and OCC index, s′∈{0, 1, . . . , 7}, based on index permutations according to some embodiments of the present disclosure;

FIG. 25 illustrates an example of RB and CDM group dependent association between CSI-RS port and OCC index, s′∈{0, 1, . . . , 7}, based on index cycling according to some embodiments of the present disclosure;

FIG. 26 illustrates an example of ports that are permuted within CDM groups according to some embodiments of the present disclosure; and

FIG. 27 illustrates an example of ports that are permuted both within CDM groups and across CDM groups according to some embodiments of the present disclosure.

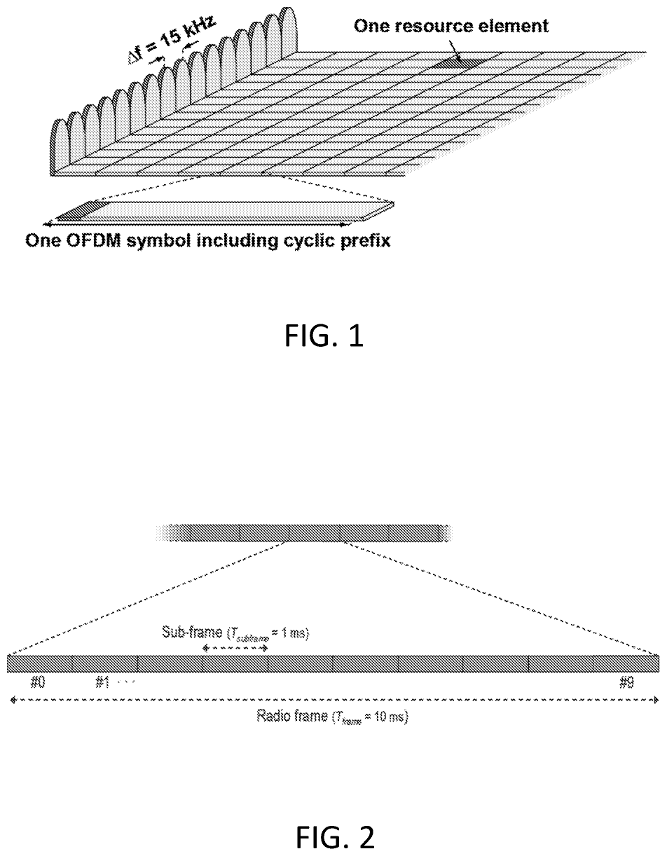

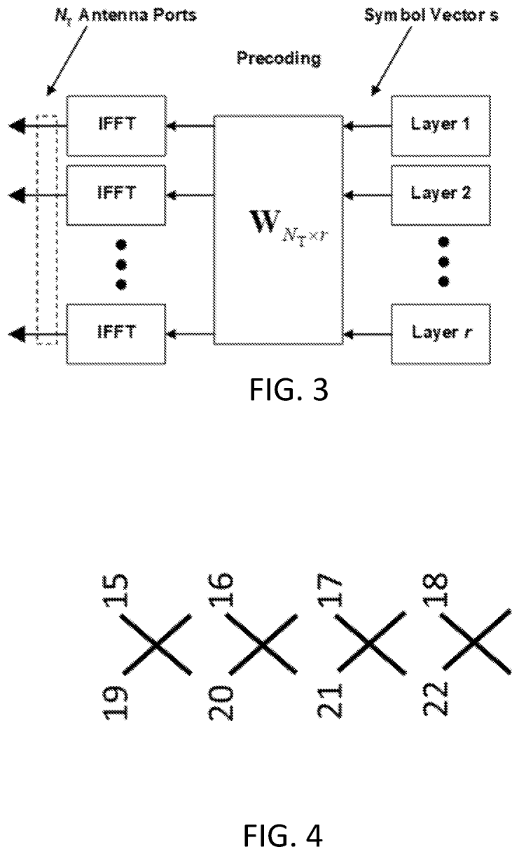

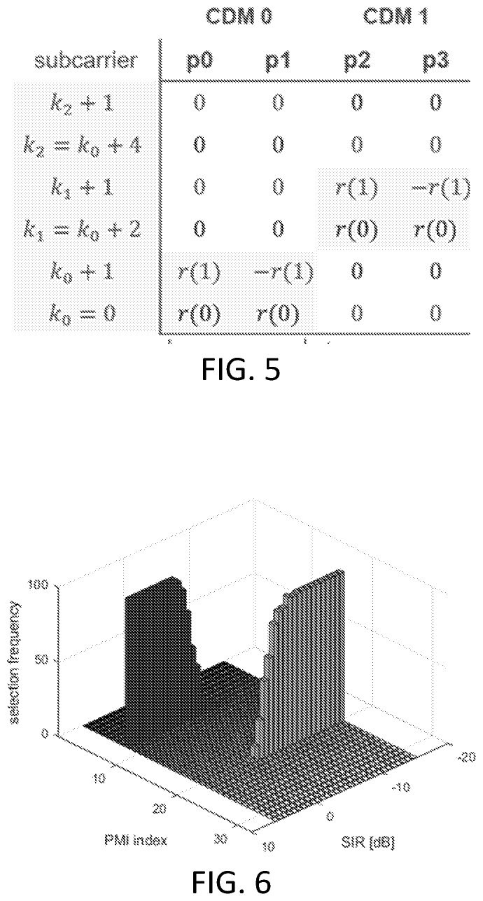

### DETAILED DESCRIPTION

From over-the-air (OTA) testing of commercial NR WDs, an issue has been found related to MIMO performance near a cell edge. The issue has been found for both 32 and 8 port CSI-RS, and for two WDs that have chipsets from different vendors.

The issue can be summarized as one or more of the following:
Near cell edge, while still connected to a serving cell A, the NR WD reports PMI as if it was served by an interfering cell B, hence false PMI selection and reporting may occur;
This may lead to a sharp drop in physical downlink shared channel (PDSCH) throughput at the cell edge;
The problem can occur when colliding CSI-RS is used in neighboring cells;
Configuration of colliding CSI-RS may have huge benefits for operators and may reduce network planning of CSI-RS, may ease migration and densification, lower interference and/or provide for minimal overhead;
The problem can occur even though a different seed is used for CSI-RS sequence generation in a serving and an interfering cell, respectively; and/or
As the analysis in this disclosure shows, the problem is due the CSI-RS design that the same CSI-RS sequence samples are repeatedly used for CDM groups in the CSI-RS resource, within the same OFDM symbol.

FIG. 6 illustrates an example of a PMI selection frequency as a function of signal to interference ratio (SIR) for a setup with one WD and two cells (served by two different network nodes). The correct PMI for the serving cell is PMI=8 and the correct PMI for the interfering cell (if the WD would have been connected to the interfering cell instead) is PMI=20. It can be seen that for SIR>0 dB, the WD reports correct PMI, while for lower SIR, the WD starts reporting PMI=20, i.e., the PMI for the interfering cell. For a well-working system, the PMI selection should instead appear random for sufficiently low SIR and that SIR level should be substantially lower than 0 dB.

According to the present disclosure, one solution to the false PMI reporting problem is to ensure that the CSI-RS signal structure is designed so that the interference term of the channel estimate, which encompasses channels of non-serving cells, appear as spatially white as possible at the receiver.

In some embodiments of the present disclosure, this may be accomplished by introducing a port specific scrambling of CSI-RS ports while preserving orthogonality between the ports of a CDM group. Several embodiments on how to achieve this is described below.

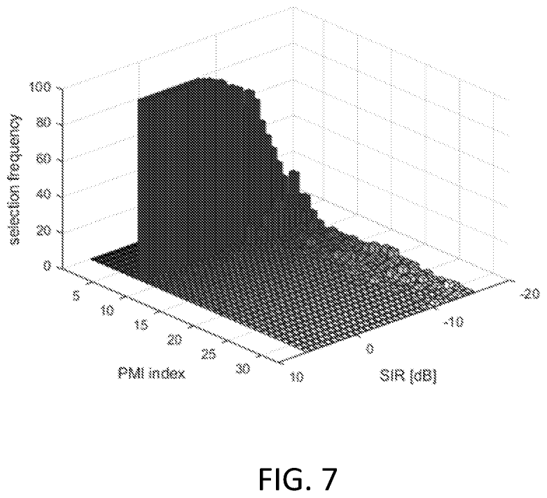

Some embodiments of the present disclosure may provide that the interference appear spatially white and thus removes the false PMI reporting problem so that the correct PMI can be reported also for SIR<0 dB. See FIG. 7, for example, which illustrates the effect of some embodiments of the present disclosure. At low SIR, the WD makes errors in selecting PMI, but the error is seemingly random (random PMI index is selected), compared to the current behaviour (e.g., as shown in FIG. 6), where the same (but wrong) PMI is selected at low SINR. Additionally, the threshold where the WD starts reporting wrong PMI is pushed to a lower SIR value (as compared to current PMI selection behaviour), which can result in better and maintained performance even under strong interference (e.g., inter-cell interference) conditions.

Before describing in detail exemplary embodiments, it is noted that the embodiments reside primarily in combinations of apparatus components and processing steps related to channel state information reference signal (CSI-RS) transmission. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Although the description herein may be explained in the context of one or more CSI-RS resource sets, it should be understood that the principles may also be applicable to other types of reference signals and reference signal configurations. Any two or more embodiments described in this disclosure may be combined in any way with each other.

In some embodiments, two or more transmissions (CSI-RS) may be considered orthogonal in at least one or more of at least four domains: time, spatial, frequency and code/sequence.

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio measurement” used herein may refer to any measurement performed on radio signals. Radio measurements can be absolute or relative. Radio measurement may be called as signal level which may be signal quality and/or signal strength. Radio measurements can be e.g., intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc. The inter-frequency and inter-RAT measurements are carried out by the WD in measurement gaps unless the WD is capable of doing such measurement without gaps. Examples of measurement gaps are measurement gap id #0 (each gap of 6 ms occurring every 40 ms), measurement gap id #1 (each gap of 6 ms occurring every 80 ms), etc. The measurement gaps are configured at the WD by the network node.

Generally, it may be considered that the network, e.g., a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g., information or payload bits, or total number of bits. The set of resources, and/or the resources of the sets, may pertain to the same carrier and/or bandwidth part, and/or may be located in the same slot, or in neighboring slots.

Receiving (or obtaining) information may comprise receiving one or more information messages (e.g., an RRC configuration parameter indicating one or more multiplier sequences for CSI-RS sequence generation). It may be considered that receiving signaling comprises demodulating and/or decoding and/or detecting, e.g., blind detection of, one or more messages, in particular a message carried by the signaling, e.g., based on an assumed set of resources, which may be searched and/or listened for the control information. It may be assumed that both sides of the communication are aware of the configurations, and may determine the set of resources, e.g., based on the reference size.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g., representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g., representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., an indication of an RRC CSI-RS configuration parameter, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

### Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g., a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g., WD) may comprise scheduling downlink and/or uplink transmissions for the terminal, e.g., downlink data and/or downlink control signaling and/or DCI and/or uplink control or data or communication signaling, in particular acknowledgement signaling, and/or configuring resources and/or a resource pool therefor. In particular, configuring a terminal (e.g., WD) may comprise configuring the WD to perform certain measurements on certain subframes or radio resources and reporting such measurements according to embodiments of the present disclosure.

A resource element may represent a smallest time-frequency resource, e.g., representing the time and frequency range covered by one symbol or a number of bits represented in a common modulation. A resource element may e.g., cover a symbol time length and a subcarrier, in particular in 3GPP and/or LTE and/or NR standards. A data transmission may represent and/or pertain to transmission of specific data, e.g., a specific block of data and/or transport block.

The term time resource used herein may correspond to any type of physical resource or radio resource expressed in terms of length of time. Examples of time resources are: symbol, time slot, subframe, radio frame, TTI, interleaving time, etc. As used herein, in some embodiments, the terms “subframe,” “slot,” subframe/slot” and “time resource” are used interchangeably and are intended to indicate a time resource and/or a time resource number.

A cell may be generally a communication cell, e.g., of a cellular or mobile communication network, provided by a node. A serving cell may be a cell on or via which a network node (the node providing or associated to the cell, e.g., base station or eNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard. One or more carriers (e.g., uplink and/or downlink carrier/s and/or a carrier for both uplink and downlink) may be associated to a cell.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide methods and apparatuses for channel state information reference signal (CSI-RS) transmission.

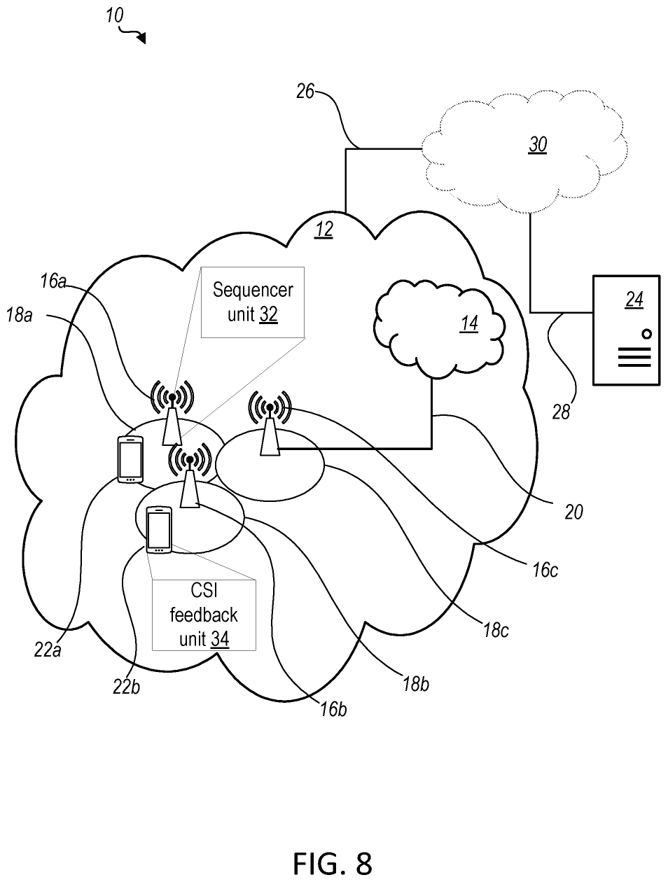

Referring again to the drawing figures, in which like elements are referred to by like reference numerals, there is shown in FIG. 8 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NB s, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network nodes 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown). The communication system of FIG. 8 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WDs 22a. Similarly, the network node 16 need not be aware of the future routing of an outgoing uplink communication originating from the WDs 22a towards the host computer 24.

A network node 16 is configured to include a sequencer unit 32 which is configured to cause the network node 16 to: configure, the WD, with at least one channel state information reference signal (CSI-RS) resource, the configuration indicating at least one multiplier sequence for the at least one CSI-RS resource; optionally, transmit CSI-RS signaling on the at least one CSI-RS resource according to the configuration; and/or optionally, receive CSI feedback based at least in part on the transmitted CSI-RS signaling. In some embodiments, network node 16 is configured to include a sequencer unit 32 which is configured to cause the network node 16 to transmit a configuration of at least one channel state information reference signal (CSI-RS) resource, the configuration indicating at least one parameter for at least one modifier for the at least one CSI-RS resource, optionally, the at least one modifier being one of at least one multiplier sequence, at least one CSI-RS port to orthogonal cover code, OCC, index permutation sequence and at least one CSI-RS port to OCC index cyclic shifting; optionally, the configuration indicating a plurality of parameters for a plurality of modifiers; optionally, at least one of the at least one parameter being used as a seed to generate the at least one multiplier sequence; and optionally, at least one of the at least one parameter being at least one cyclic shift value for cyclic shifting of the at least one CSI-RS port; optionally, transmit CSI-RS signaling on the at least one CSI-RS resource according to the configuration; and/or optionally, receive a CSI feedback based at least in part on the transmitted CSI-RS signaling.

A wireless unit 22 is configured to include a CSI feedback unit 34 which is configured to cause the wireless unit 22 to receive a configuration of at least one channel state information reference signal (CSI-RS) resource, the configuration indicating at least one multiplier sequence for the at least one CSI-RS resource; optionally, receive CSI-RS signaling on the at least one CSI-RS resource according to the configuration; and/or optionally, perform a measurement on the received CSI-RS signaling and/or transmit CSI feedback, the CSI feedback based at least in part on the measurement on the received CSI-RS signaling. In some embodiments, a wireless unit 22 is configured to include a CSI feedback unit 34 which is configured to cause the wireless unit 22 to receive a configuration of at least one CSI-RS resource, the configuration indicating at least one parameter for at least one modifier for the at least one CSI-RS resource, optionally, the at least one modifier being one of at least one multiplier sequence, at least one CSI-RS port to orthogonal cover code, OCC, index permutation sequence and at least one CSI-RS port to OCC index cyclic shifting; optionally, the configuration indicating a plurality of parameters for a plurality of modifiers; optionally, at least one of the at least one parameter being used as a seed to generate the at least one multiplier sequence; and optionally, at least one of the at least one parameter being at least one cyclic shift value for cyclic shifting of the at least one CSI-RS port; optionally, receive a CSI-RS signaling on the at least one CSI-RS resource according to the configuration; and/or optionally, perform a measurement on the received CSI-RS signaling and/or transmitting a CSI feedback, the CSI feedback based at least in part on the measurement on the received CSI-RS signaling.

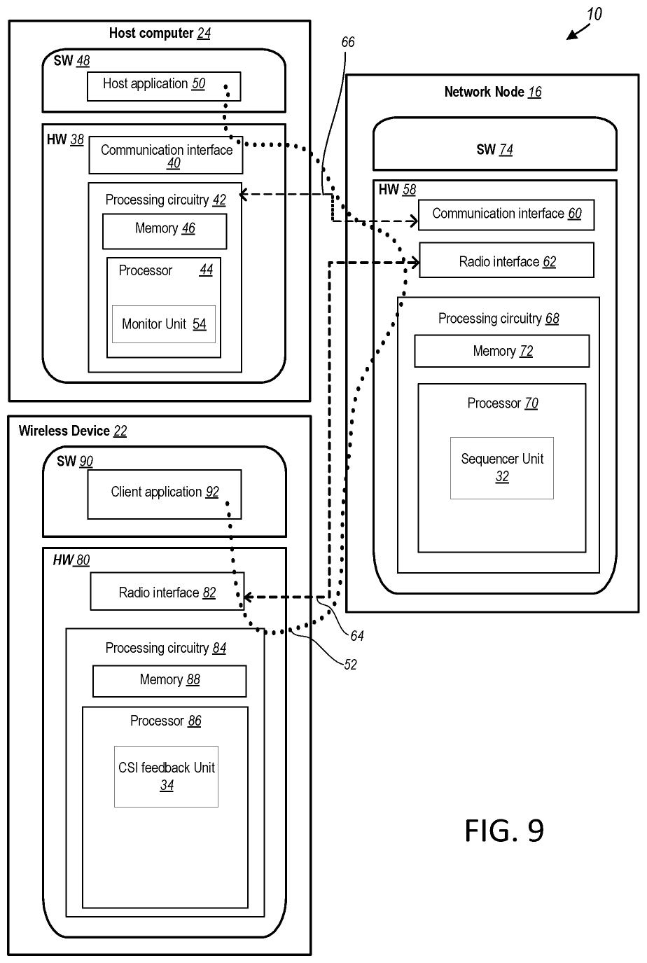

Example implementations, in accordance with an embodiment, of the WD 22, network node 16 and host computer 24 discussed in the preceding paragraphs will now be described with reference to FIG. 9. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network nodes 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

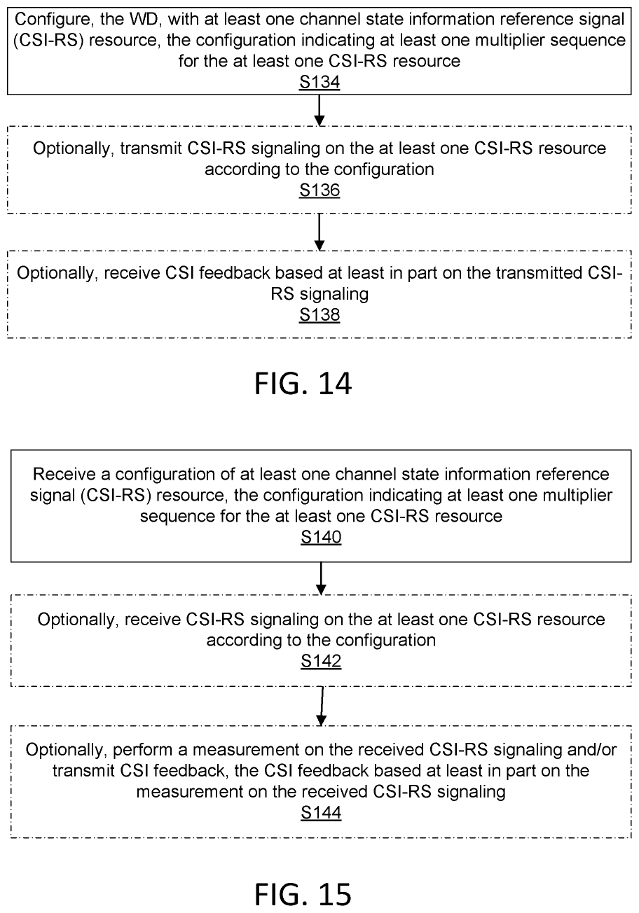

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network nodes 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network nodes 16. For example, processing circuitry 68 of the network node 16 may include sequencer unit 32 configured to perform network node methods discussed herein, such as the methods discussed with reference to FIG. 14 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless unit 22 may include a CSI feedback unit 34 configured to perform WD methods discussed herein, such as the methods discussed with reference to FIG. 15 as well as other figures.

In some embodiments, the inner workings of the network node 16, WD 22, and host computer 24 may be as shown in FIG. 9 and independently, the surrounding network topology may be that of FIG. 8.

In FIG. 9, the OTT connection 52 has been drawn abstractly to illustrate the communication between the host computer 24 and the wireless unit 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc. The reconfiguring need not affect the network node 16, and the reconfiguring may be unknown or imperceptible to the network nodes 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network nodes 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 8 and 9 show various “units” such as sequencer unit 32, and CSI feedback unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

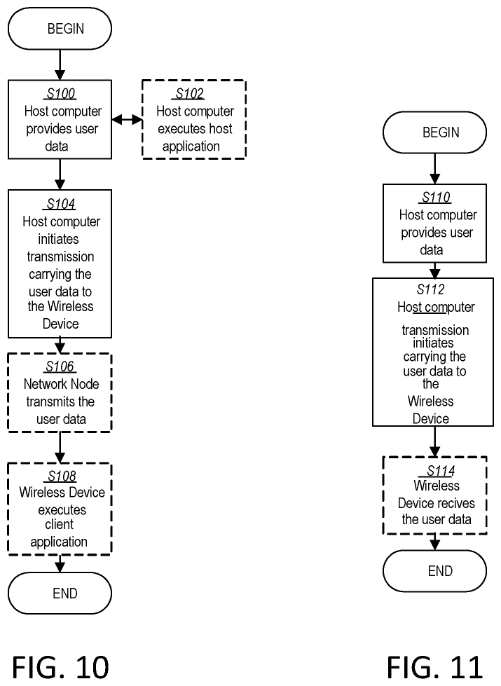

FIG. 10 is a flowchart illustrating an exemplary method implemented in a communication system, such as, for example, the communication system of FIGS. 8 and 9, in accordance with one embodiment. The communication system may include a host computer 24, a network node 16 and a WD 22, which may be those described with reference to FIG. 9. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 11 is a flowchart illustrating an exemplary method implemented in a communication system, such as, for example, the communication system of FIG. 8, in accordance with one embodiment. The communication system may include a host computer 24, a network node 16 and a WD 22, which may be those described with reference to FIGS. 8 and 9. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

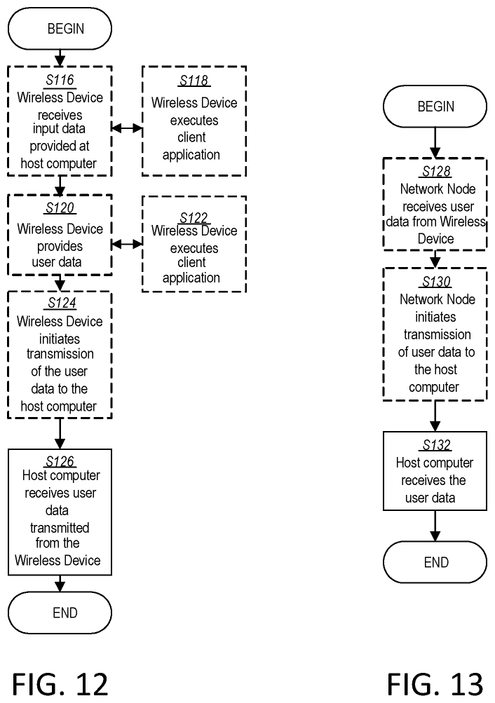

FIG. 12 is a flowchart illustrating an exemplary method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 13 is a flowchart illustrating an exemplary method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 14 is a flowchart of an exemplary process in a network node 16 for configuring reference signal sequences according to some embodiments of the present disclosure. One or more Blocks and/or functions and/or methods performed by the network node 16 may be performed by one or more elements of network node 16 such as by sequencer unit 32 in processing circuitry 68, processor 70, communication interface 60, radio interface 62, etc. according to the example method. The example method includes configuring (Block S134), such as via sequencer unit 32, processing circuitry 68, processor 70, communication interface 60 and/or radio interface 62, a wireless device (WD), with at least one channel state information reference signal (CSI-RS) resource, the configuration indicating at least one multiplier sequence for the at least one CSI-RS resource. The method includes optionally, transmitting (Block S136), such as via sequencer unit 32, processing circuitry 68, processor 70, communication interface 60 and/or radio interface 62, CSI-RS signaling on the at least one CSI-RS resource according to the configuration. The method includes optionally, receiving (Block S138), such as via sequencer unit 32, processing circuitry 68, processor 70, communication interface 60 and/or radio interface 62, CSI feedback based at least in part on the transmitted CSI-RS signaling.

In some embodiments, the at least one multiplier sequence is at least one port-specific multiplier sequence. In some embodiments, the at least one port-specific multiplier sequence corresponds to at least one port-specific multiplier sequence that is different for each antenna port of a code division multiplexing (CDM) group for CSI-RS. In some embodiments, the configuration is via radio resource control (RRC) signaling. In some embodiments, at least one of the at least one multiplier sequence is generated by a function that is based at least in part on at least one of: a resource block index, n, the resource block index indicating a resource block on which the CSI-RS signaling is transmitted; and a code division multiplexing (CDM) group index, s, the CDM group index indicating an orthogonal cover code.

In some embodiments, for at least one antenna port in the CSI-RS configuration, a CSI-RS resource is configured with a reference signal sequence that is not generated using the at least one multiplier sequence, while, for at least one other antenna port in the CSI-RS configuration, a CSI-RS resource is configured with a reference signal sequence that is generated using the at least one multiplier sequence. In some embodiments, for at least one antenna port in the CSI-RS configuration, a reference signal sequence is configured to be generated by a pseudo-random sequence generator multiplied by at least one of the at least one multiplier sequence. In some embodiments, the CSI feedback includes a precoding matrix indicator (PMI).

FIG. 15 is a flowchart of an exemplary process in a wireless unit 22 for receiving reference signal sequences according to a configuration according to some embodiments of the present disclosure. One or more Blocks and/or functions and/or methods performed by WD 22 may be performed by one or more elements of WD 22 such as by CSI feedback unit 34 in processing circuitry 84, processor 86, radio interface 82, etc. The example method includes receiving (Block S140), such as via CSI feedback unit 34, processing circuitry 84, processor 86 and/or radio interface 82, a configuration of at least one channel state information reference signal (CSI-RS) resource, the configuration indicating at least one multiplier sequence for the at least one CSI-RS resource. The method includes optionally, receiving (Block S142), such as via CSI feedback unit 34, processing circuitry 84, processor 86 and/or radio interface 82, CSI-RS signaling on the at least one CSI-RS resource according to the configuration. The method includes optionally, performing (Block S144), such as via CSI feedback unit 34, processing circuitry 84, processor 86 and/or radio interface 82, a measurement on the received CSI-RS signaling and/or transmitting CSI feedback, the CSI feedback based at least in part on the measurement on the received CSI-RS signaling.

In some embodiments, the at least one multiplier sequence is at least one port-specific multiplier sequence. In some embodiments, the at least one port-specific multiplier sequence corresponds to at least one port-specific multiplier sequence that is different for each antenna port of a code division multiplexing (CDM) group for CSI-RS. In some embodiments, the configuration is via radio resource control (RRC) signaling. In some embodiments, at least one of the at least one multiplier sequence is generated by a function that is based at least in part on at least one of: a resource block index, n, the resource block index indicating a resource block on which the CSI-RS signaling is transmitted; and a code division multiplexing (CDM) group index, s, the CDM group index indicating an orthogonal cover code.

In some embodiments, for at least one antenna port in the CSI-RS configuration, a CSI-RS resource is configured with a reference signal sequence that is not generated using the at least one multiplier sequence, while, for at least one other antenna port in the CSI-RS configuration, a CSI-RS resource is configured with a reference signal sequence that is generated using the at least one multiplier sequence. In some embodiments, for at least one antenna port in the CSI-RS configuration, a reference signal sequence is configured to be generated by a pseudo-random sequence generator multiplied by at least one of the at least one multiplier sequence. In some embodiments, the CSI feedback includes a precoding matrix indicator (PMI).

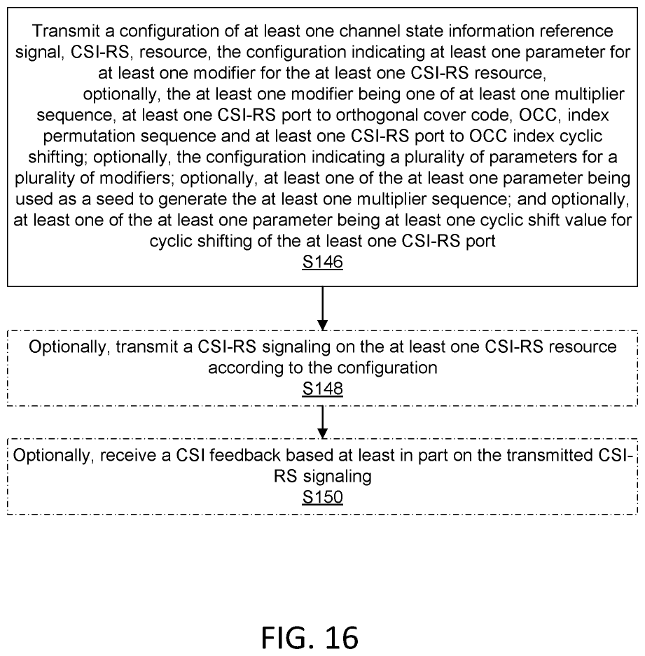

FIG. 16 is a flowchart of an exemplary process in a network node 16 for configuring reference signal sequences according to some embodiments of the present disclosure. One or more Blocks and/or functions and/or methods performed by the network node 16 may be performed by one or more elements of network node 16 such as by sequencer unit 32 in processing circuitry 68, processor 70, communication interface 60, radio interface 62, etc. according to the example method. The example method includes transmitting (Block S146), such as via sequencer unit 32, processing circuitry 68, processor 70, communication interface 60 and/or radio interface 62, a configuration of at least one channel state information reference signal, CSI-RS, resource, the configuration indicating at least one multiplier sequence for the at least one CSI-RS resource, the configuration indicating at least one parameter for at least one modifier for the at least one CSI-RS resource, optionally, the at least one modifier being one of at least one multiplier sequence, at least one CSI-RS port to orthogonal cover code, OCC, index permutation sequence and at least one CSI-RS port to OCC index cyclic shifting; optionally, the configuration indicating a plurality of parameters for a plurality of modifiers; optionally, at least one of the at least one parameter being used as a seed to generate the at least one multiplier sequence; and optionally, at least one of the at least one parameter being at least one cyclic shift value for cyclic shifting of the at least one CSI-RS port. The method includes optionally, transmitting (Block S148), such as via sequencer unit 32, processing circuitry 68, processor 70, communication interface 60 and/or radio interface 62, a CSI-RS signaling on the at least one CSI-RS resource according to the configuration. The method includes optionally, receiving (Block S150), such as via sequencer unit 32, processing circuitry 68, processor 70, communication interface 60 and/or radio interface 62, a CSI feedback based at least in part on the transmitted CSI-RS signaling.

In some embodiments, the at least one multiplier sequence comprises at least one port-specific multiplier sequence. In some embodiments, the at least one port-specific multiplier sequence comprises at least one port-specific multiplier sequence that is different for each antenna port of a code division multiplexing, CDM, group. In some embodiments, transmitting the configuration comprises transmitting, such as via sequencer unit 32, processing circuitry 68, processor 70, communication interface 60 and/or radio interface 62, the configuration via radio resource control, RRC, signaling. In some embodiments, at least one of the at least one multiplier sequence is based at least in part on at least one of a resource block index, n, the resource block index indicating a resource block on which the CSI-RS signaling is transmitted.

In some embodiments, each of the at least one multiplier sequence varies across a plurality of resource blocks, RBs. In some embodiments, at least one of the at least one multiplier sequence is based at least in part on a code division multiplexing, CDM, group index, s, the CDM group index indicating an orthogonal cover code. In some embodiments, for at least one antenna port in the configuration, a CSI-RS resource is configured with a reference signal sequence that is not based on the at least one multiplier sequence, while, for at least one other antenna port in the configuration, a CSI-RS resource is configured with a reference signal sequence that is based on the at least one multiplier sequence. In some embodiments, for at least one antenna port in the configuration, a reference signal sequence is configured to be generated by a pseudo-random sequence generator multiplied by at least one of the at least one multiplier sequence. In some embodiments, at least one of a reference signal sequence and at least one of the at least one multiplier sequence is a pseudo-random sequence, the pseudo-random sequence being a Gold sequence.

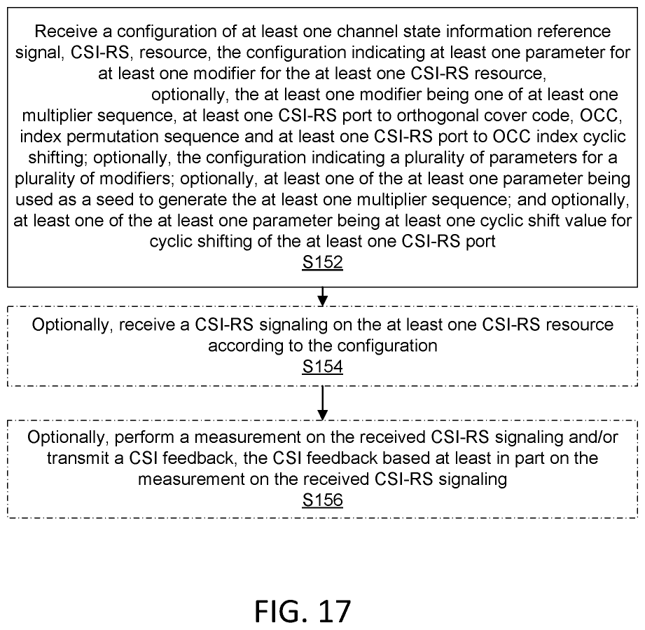

FIG. 17 is a flowchart of an exemplary process in a wireless unit 22 for receiving reference signal sequences according to a configuration according to some embodiments of the present disclosure. One or more Blocks and/or functions and/or methods performed by WD 22 may be performed by one or more elements of WD 22 such as by CSI feedback unit 34 in processing circuitry 84, processor 86, radio interface 82, etc. The example method includes receiving (Block S152), such as via CSI feedback unit 34, processing circuitry 84, processor 86 and/or radio interface 82, a configuration of at least one channel state information reference signal, CSI-RS, resource, the configuration indicating at least one parameter for at least one modifier for the at least one CSI-RS resource, optionally, the at least one modifier being one of at least one multiplier sequence, at least one CSI-RS port to orthogonal cover code, OCC, index permutation sequence and at least one CSI-RS port to OCC index cyclic shifting; optionally, the configuration indicating a plurality of parameters for a plurality of modifiers; optionally, at least one of the at least one parameter being used as a seed to generate the at least one multiplier sequence; and optionally, at least one of the at least one parameter being at least one cyclic shift value for cyclic shifting of the at least one CSI-RS port. The method includes optionally, receiving (Block S154), such as via CSI feedback unit 34, processing circuitry 84, processor 86 and/or radio interface 82, a CSI-RS signaling on the at least one CSI-RS resource according to the configuration. The method includes optionally, performing (Block S156), such as via CSI feedback unit 34, processing circuitry 84, processor 86 and/or radio interface 82, a measurement on the received CSI-RS signaling and/or transmitting a CSI feedback, the CSI feedback based at least in part on the measurement on the received CSI-RS signaling.

In some embodiments, the at least one multiplier sequence comprises at least one port-specific multiplier sequence. In some embodiments, the at least one port-specific multiplier sequence comprises at least one port-specific multiplier sequence that is different for each antenna port of a code division multiplexing, CDM, group. In some embodiments, receiving the configuration comprises receiving, such as via CSI feedback unit 34, processing circuitry 84, processor 86 and/or radio interface 82, the configuration via radio resource control, RRC, signaling. In some embodiments, at least one of the at least one multiplier sequence is based at least in part on at least one of a resource block index, n, the resource block index indicating a resource block on which the CSI-RS signaling is transmitted. In some embodiments, each of the at least one multiplier sequence varies across a plurality of resource blocks, RBs.

In some embodiments, at least one of the at least one multiplier sequence is based at least in part on a code division multiplexing, CDM, group index, s, the CDM group index indicating an orthogonal cover code. In some embodiments, for at least one antenna port in the configuration, a CSI-RS resource is configured with a reference signal sequence that is not based on the at least one multiplier sequence, while, for at least one other antenna port in the configuration, a CSI-RS resource is configured with a reference signal sequence that is based on the at least one multiplier sequence. In some embodiments, for at least one antenna port in the configuration, a reference signal sequence is configured to be generated by a pseudo-random sequence generator multiplied by at least one of the at least one multiplier sequence. In some embodiments, at least one of a reference signal sequence and at least one of the at least one multiplier sequence is a pseudo-random sequence, the pseudo-random sequence being a Gold sequence.

Having described the general process flow of arrangements of the disclosure and having provided examples of hardware and software arrangements for implementing the processes and functions of the disclosure, the sections below provide details and examples of arrangements for channel state information reference signal (CSI-RS) transmission, which may be implemented by the network node 16, wireless unit 22 and/or host computer 24.

Generally, NR terminals (e.g., WDs 22) are configured with a CSI-RS resource of multiple CDM groups in an OFDM symbol, according to 3GPP Release 15 (Rel. 15) specifications. Frequency-domain locations of CDM groups may be given by k₀, k₁, k₂ etc. where kᵢ, i ∈{0, 1, 2, .. } indicates the subcarrier position and where each CDM group occupies two subcarriers (kᵢ,kᵢ+1) (and also multiple symbols).

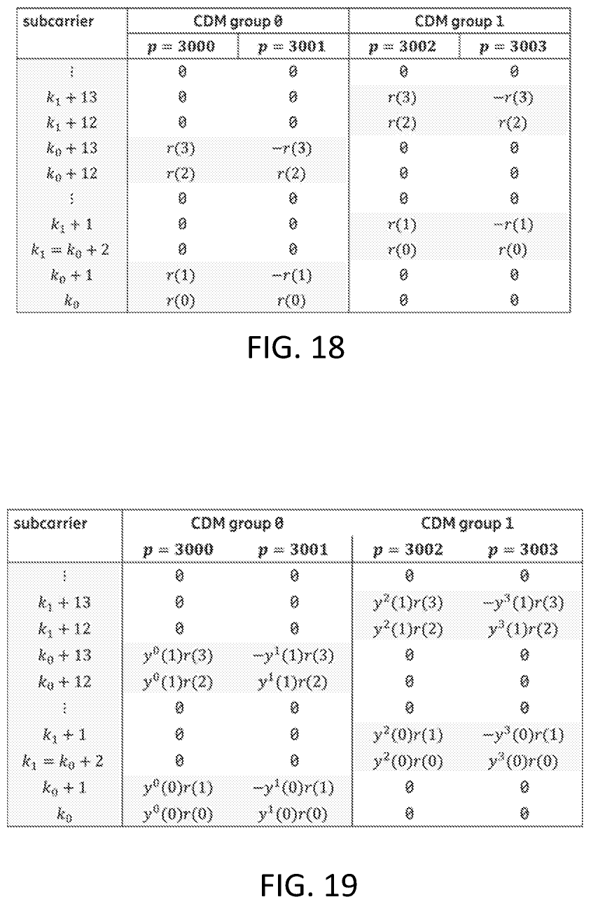

Due to the 3GPP Release 15 (Rel. 15) technical specifications (TS), the same CSI-RS sequence may be mapped to all CDM groups, so the first CDM group uses samples r(0),r(1) and the second, third, etc. CDM group also use samples r(0),r(1). This repetition may be considered a root-cause for creating the false PMI reporting. This is illustrated in FIG. 18 by two CDM groups, p=1 and four CSI-RS ports. These ports are numbered in NR starting with port number 3000, hence ports 3000-3003 are mapped to two CDM groups, 0 and 1, respectively. A RB has 12 subcarriers. The two first ports (3000 and 3001) are mapped to subcarriers k₀, k₀+1, hence adjacent subcarriers. The same samples r(0),r(1) are used for these two ports in these two subcarriers, multiplied with the length two OCC code, where port 3000 use code [1 1] and port 3000 use code [1 -1]. Now, for port 3002 and 3003, which are mapped to the next CDM group of subcarriers k₁, k₁+1, the same samples r(0),r(1) are re-used.

In one embodiment of the present disclosure, illustrated by the example in FIG. 19, a new sequence y^{p′}n) per port p′ (p=3000+p′) is introduced and multiplied with the original sequence. The index n runs over the resource blocks, so in each RB a new value is selected. If the CDM group spans multiple OFDM symbols, the same value y^{p′}n) may be used in all these OFDM symbols.

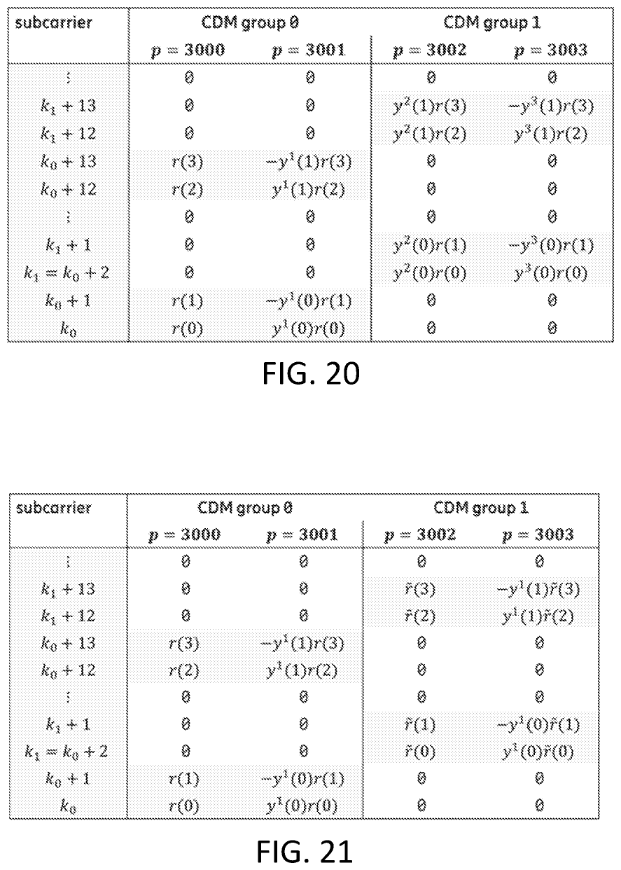

In FIG. 20, an alternative embodiment is shown, for example, where port p=3000 does not have a multiplier sequence y^{p′}n). The benefit is that this port is unchanged with respect to NR 3GPP Release 15, which can be useful since port p=3000 is used for the Tracking Reference Signal (TRS), and it could be beneficial if this is unchanged if the new sequences is introduced for WDs 22 of a later release.

In yet another embodiment, illustrated in FIG. 21, the 3GPP Release 15 reference signal sequence is used for the first CDM group (the CDM group that contains port p=3000). The other CDM group uses an alternative sequence, \tilde{r}(m), which may be generated using a different seed compared to the sequence used for the first CDM group. In this embodiment, the multiplier sequence is the same across CDM groups, i.e., the multiplier sequence depends on the CDM index s, used to indicate one of the orthogonal cover codes, as well as, on the RB index n. FIG. 21 illustrates an embodiment where a different reference signal sequence is used for CDM group 1 compared to CDM group 0, and where the multiplier sequence depends on the orthogonal cover code index s, so y^{s}(n), s=0, 1, . . . , L−1, is used for all CDM groups. Here, y⁰(n)=1.

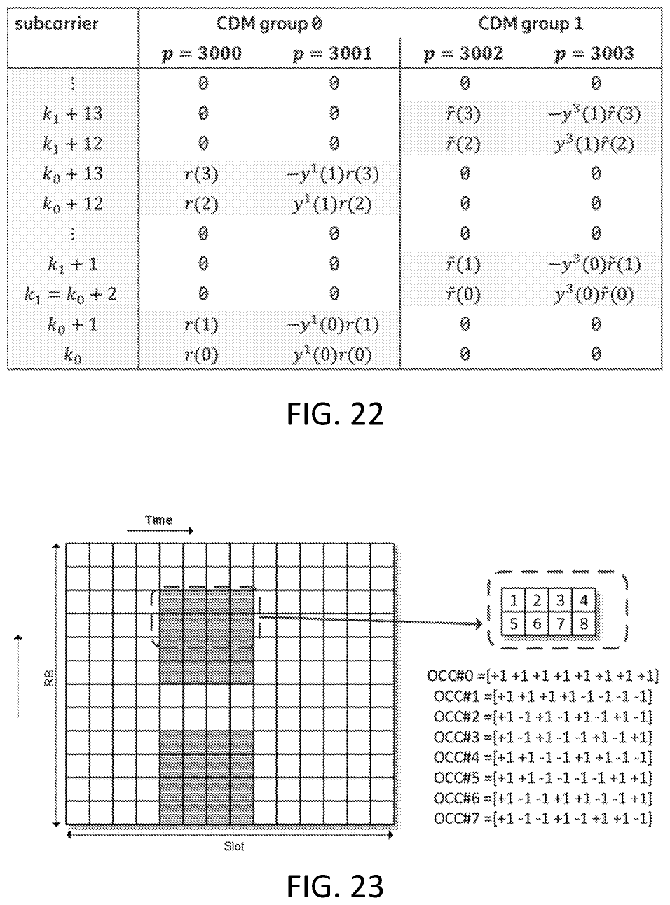

In yet another embodiment, illustrated by the example of FIG. 22, the 3GPP Release 15 sequence is used for the first CDM group (the CDM group that contains port p=3000). The other CDM group uses an alternative sequence, \tilde{r}(m), which may be generated using a different seed (or different points from a longer sequence) compared to the sequence, r(m), used for the first CDM group. The multiplier sequence y^{p′}(n) is in this case different for all ports p and depends on the RB index n. FIG. 22 illustrates an embodiment where a different sequence is used for CDM group 1 compared to CDM group 0 but different multiplier sequences y^{p′}(n) is used for all ports p. Here, y^{p′}n)=1 is used for first port within a CDM group.

In one embodiment, a port-specific reference signal sequence, z^{p′}(t), to be mapped on M resource elements, is constructed by applying a length-L orthogonal cover code, W^{p′ mod L} (t mod L), for example a Walsh-Hadamard code, in conjunction with a port-specific multiplier-sequence y^{p′}(└t/L┘) of length M/L, to a pseudo-random sequence r(t) of length M as

z^{p′}(t)=w^{p′ mod L}(t mod L)·y^{p′}(└t/L┘)·r(t),
t=0, 1, . . . , M−1, p′=0, 1, . . . , X−1.

In another embodiment, the pseudo-random sequence r(t) is CDM group specific

z^{p′}(t)=w^{p′mod L}(t mod L)·y^{p′}(└t/L┘)·rⱼ(t), j=0, 1, . . . , X/L−1.

The mapping of the z^{p′}(t) to elements in the resource element grid of an OFDM system (i.e., the mapping of the OCC) can be across frequency (subcarriers), across time (OFDM symbols) or across both time and frequency as exemplified in FIG. 23.

FIG. 23 is an example OFDM grid of subcarriers and OFDM symbols. The CSI-RS resource mapping is marked, including four CDM groups. Each CDM group is used to map 8 ports, hence in total 32 ports in this example. A CDM group uses 4 OFDM symbols and 2 subcarriers, in total 8 resource elements. A Walsh Hadamard orthogonal cover code (OCC) of length 8 is thus used to separate the 8 ports and each port is using one of the OCC codes. The OCC is mapped across time and frequency in this example.

In versions of the embodiments, the port-specific multiplier-sequence y^{p′}(└t/L┘) may be omitted for one port associated with a CDM and may be constructed from cyclic-shifted versions of the pseudo-random sequence(s).

In one embodiment, a multiplier sequence y^{p′}n) is, for CSI-RS port p=3000 +p′, applied to the NR 3GPP Release 15 resource element mapping as,

a_{k,l}^{(p,μ)=β}_{CSIRS}W_{f}(k′)·wₜ(l′)·y^{p′}(n)·r_{l,n}_{_{s,f}}(m′).

The sequences y^{p′}(n), p′=0, 1, . . . , X−1, may be CSI-RS port-specific, in which each port has its own multiplier-sequence. In one version, CSI-RS port 3000 is mapped as in NR Release 15 which implies that y⁰(n)=1.

In another embodiment, a multiplier sequence y^{p′}(n) is, for CSI-RS port p=3000 +p′, applied to a CDM group specific reference signal, r_{j,l,n}_{_{s,f}}(m′), modifying the NR Release 15 mapping as,

a_{k,l}^{(p,μ)=β}_{CSIRS}W_{f}(k′)·wₜ(l′)·y^{p′}(n)·r_{l,n}_{_{s,f}}(m′).

The sequences y^{p′}n), p′=0, 1, . . . , X−1, may be CSI-RS port-specific (a function of p′) or be specific to ports within CDM groups, in which y^{p′}n)=y^{s}(n) with s=p′ modulus L. For CDM group 0, the NR 3GPP Release 15 reference signal may be reused, i.e., r_{0,l,n}_{_{s,f}}(m′)=r_{l,n}_{_{s,f}}(m′), and the CSI-RS port 3000 may be mapped as in NR Release 15 which implies that y⁰(n)=1, in at least CDM group 0.

The CDM group specific reference signal r_{j,l,n}_{_{s,f}}(m′) may refer to a pseudo-random sequence and may then be a Gold-31 sequence with generator polynomial defined in, for example, 3GPP Technical Specification (TS) 38.211. The initialization of the pseudo-random sequence generator may be CDM group specific. Alternatively, or additionally, the CDM group specific reference signals r_{j,l,n}_{_{s,f}}(m′) may refer to a subsampled long pseudo-random sequence which in turn may refer to a Gold-31 sequence with generator polynomial defined in, for example, 3GPP TS 38.211. One example of using a long pseudo-random sequence is to introduce subcarrier specific reference signals r̅_{l,n}_{_{s,f}}(k) from which the reference signal samples associated with a CDM group implicitly follows from k. Note that the above modifications to the sequence mapping (related to r_{j,l,n}_{_{s,f}}(m′)) may or may not be combined with the introduction of the multiplier sequence also described herein.

The sequence y^{p′}(n) may be extracted from, or refer to, a pseudo-random sequence, r^{y}(n′), or a function of a pseudo-random sequence, where r^{y}(n′) may refer to a Gold-31 sequence with generator polynomial according to, for example, 3GPP TS 38.211 (incorporated herein by reference). The initialization of the pseudo-random sequence generator, cᵢₙᵢₜ^{y}, may be a function of a scrambling identifier (ID), n_{ID}, or/and port number p or CDM/OCC index. Dependence of port index may be useful if the sequence is port specific. Thus, cᵢₙᵢₜ^{y} may be CSI-RS port specific or CDM/OCC code specific.

The sequence y^{p′}n) may be extracted from r^{y}(n′) as r^{y}(f̅(p, n)), where one example could be f̅(p, n)=n·X+p where X is total number of ports in the CSI-RS resource and n is a counter of RBs. One example (preferred) is,

y^{p′}(n)=r^{y}(n·X+p′)

cᵢₙᵢₜ^{y}=(2¹⁰(N_{symb}^{slot}n_{s,f}+1)*(2n_{ID}+1)+n_{ID})mod 2³¹.

In another embodiment, the same sequence points are reused in multiple RBs, and there may be f̅(p₁, n₁)=f̅(p₂, n₂) if n₁≠n₂, where y^{p′}n) may be identical to one if this is configured or if the signaling is absent, i.e., by default this parameter is one unless indicated from the network node 16 to the WD 22 using higher layer signaling (e.g., RRC signalling) (to keep compatibility with legacy devices).

In NR, in some embodiments, the association between a CSI-RS port p and OCC index, s′ and the OCC group it is mapped to is fixed and depends only on the port number as s′=(p−3000) modulus L, where L is the CDM group size. See Table 2 above. An alternative to introduce the sequence y^{p′}n), for solving the PMI selection issue, may be to let the association between a port and OCC index within OCC group, and possibly also OCC group also depend on RB number, n, and CDM group, and possibly also a scrambling ID, e.g., n_{ID}.

In another embodiment, the association between a CSI-RS port and OCC index, s′∈{0, 1, . . . , L−1}, is determined by a function s′=f(p, n, L) that takes port index p, RB number, n, and CDM group size L as input arguments. Note that the CDM group index is implicitly given by j=└(p−3000)/L┘. This function has the property that ports associated with a CDM group have a one-to-one mapping to the OCC index s′ and that this one-to-one mapping differs between CDM groups and depends on the RB.

The permutation function f(p, n, L) may depend on n_{ID}.

This function may represent a permutation function of a vector [0, 1, . . . , L−1], as illustrated in FIG. 23 for a CSI-RS configuration of 16 ports and two CDM groups. In this illustration, the function generates permutations of the vector [0 1 2 3 4 5 6 7] that depend on RB and CDM group.

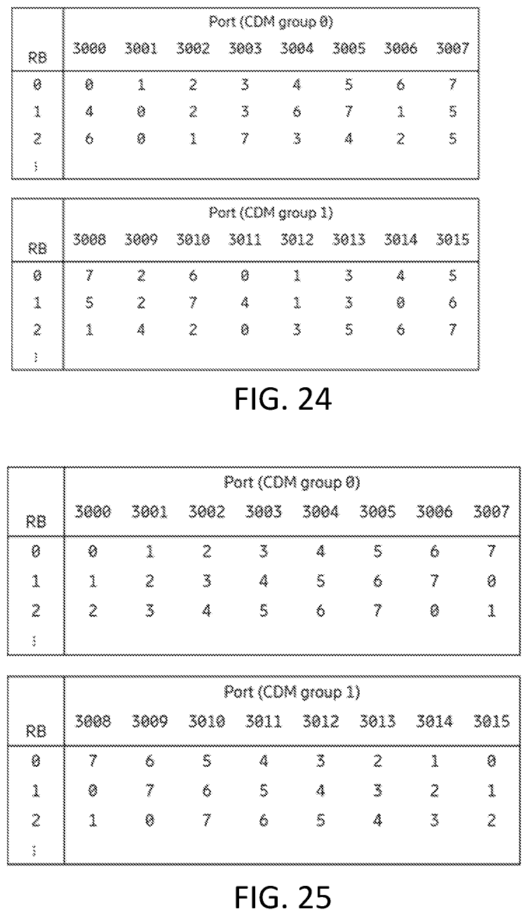

FIG. 24 illustrates an example of RB and CDM group dependent association between CSI-RS port and OCC index, s′∈{0, 1, . . . , 7}, based on index permutations.

In a version of this embodiment, the function is realized as a cyclic-shifting function, as illustrated in FIG. 24, for example, for a CSI-RS configuration of 16 ports and two CDM groups. In this illustration, the function cyclic shifts the vector [0 1 2 3 4 5 6 7] (one shift) for CDM group 0 and the vector [7 6 5 4 3 2 1 0] (one shift) for CDM group 1 with respect to RB number. These vectors may be RRC configured per CDM group and may be cyclic shifted in different directions and with different shift steps.

One embodiment could be a cyclic shifting of the port indices, f(p′, n)=(p′mod L+g(n, n_{ID}))mod L, where g(n, n_{ID}) is computed from a Gold sequence initialized with a seed dependent of n_{ID}.

Another embodiment, assumes it is known that the channel correlation between two antenna ports that maps to different polarizations is low. In NR, if cross-polarized antennas are used, the port n and port n+P/2 for n=3000, . . . ,3000+P/2−1 maps to different polarizations. It is observed that the problem of false PMI reduces if ports of different polarizations are separated of a CDM of length L=2. Ports of a CSI-RS resource are numbered within a CDM group first and then across CDM groups. Hence, in some embodiments the port numbering is redefined so that two ports with different polarizations are separated by an OCC in the same CDM group. For example, such port numbering can be, for a P=4 port CSI-RS resource with 2 CDM groups, altered from {3000, 3001, 3002, 3003}to a new ordering as {3000, 3002, 3001, 3003}which means that CDM group 0 uses port {3000, 3002}and CDM group 1 uses port {3001, 3003}. Since port 3000 and 3002 represent different polarizations in a cross-polarized antenna array, this mapping may improve performance and reduce false PMI detection. In general, the new mapping may be {3000, 3000+P/2, 3001, 3000+P/2+1, 3002, 3000+P/2+2, . . . }. This can also be specified as a port re-numbering function, for example, using a permutation matrix.

In another embodiment, the association between CDM group index, j, and OCC index (of OCC code) are both permuted in a way that depends on the RB number, which may result in,

j=└(p″)/L┘,

s=(p″)mod L.

And, in some embodiments, the permuted port index may be computed from the port index using a permutation function p″=f(p′, n, X) (embodiments related to this permutation function is mirroring those for the case of permutation only within CDM groups as described above).

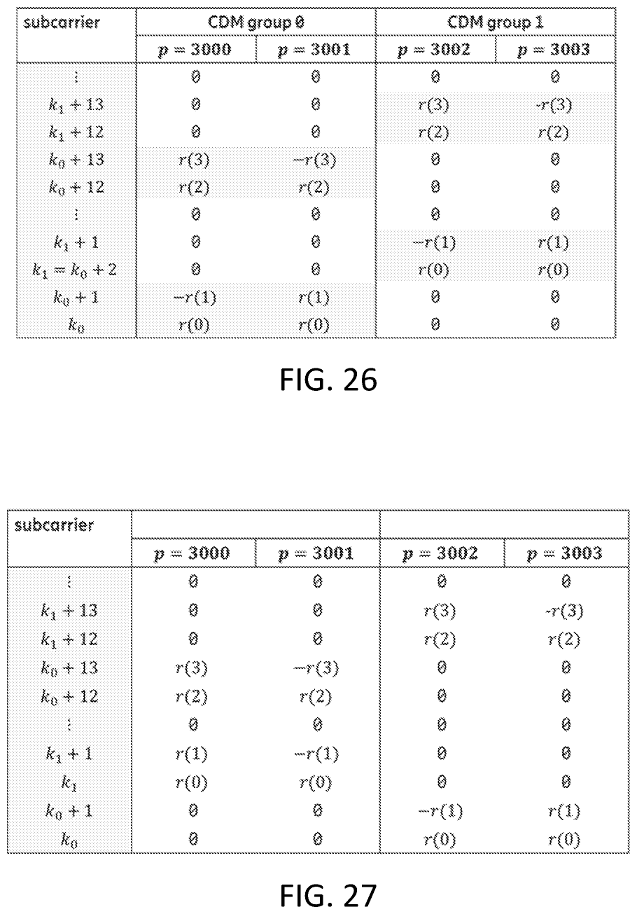

FIG. 25 illustrates an example of RB and CDM group dependent association between CSI-RS port and OCC index, s′∈{0, 1, . . . , 7}, based on index cycling. FIG. 26 illustrates an example of ports that are permuted within CDM groups as in one of the embodiments. FIG. 27 illustrates an example of ports that are permuted both within CDM groups and across CDM groups as in one of the embodiments.

In yet another embodiment, a single seed is used to generate a sequence r_{l,n}_{_{s,f}}(m′) as in 3GPP Rel. 15 but for CSI-RS port p=3000+p′, a sequence shift f(p′) is applied to the sequence in order to generate pseudo orthogonal sequences. For example,

a_{k,l}^{(p,μ)}=β_{CSIRS}w_{f}(k′)·wₜ(l′)·r_{l,n}_{_{s,f}}(C·m′+f(p′)).

The shift f(p′) can for example be a linear function f(p′)=A+B·p′ where A, B and C are constants including the possible values A=0, C=1.

Some embodiments of the present disclosure provide for the CSI-RS sequence to be augmented by a multiplication with new sequence such that the sequence varies at least across RBs. Furthermore, the new sequence is specific per port at least within CDM groups. Alternatively, or additionally, in some embodiments, the mapping of CSI-RS ports to CDM groups and/or CDM codes is made such that it varies across RBs.

Some embodiments may include one or more of the following:

Embodiment A1. A network node configured to communicate with a wireless device (WD), the network node configured to, and/or comprising a radio interface and/or comprising processing circuitry configured to:

configure, the WD, with at least one channel state information reference signal (CSI-RS) resource, the configuration indicating at least one multiplier sequence for the at least one CSI-RS resource;

optionally, transmit CSI-RS signaling on the at least one CSI-RS resource according to the configuration; and/or

optionally, receive CSI feedback based at least in part on the transmitted CSI-RS signaling.

Embodiment A2. The network node of Embodiment A1, wherein the at least one multiplier sequence is at least one port-specific multiplier sequence.

Embodiment A3. The network node of Embodiment A2, wherein the at least one port-specific multiplier sequence corresponds to at least one port-specific multiplier sequence that is different for each antenna port of a code division multiplexing (CDM) group for CSI-RS.

Embodiment A4. The network node of any one of Embodiments A1-A3, wherein the configuration is via radio resource control (RRC) signaling.

Embodiment A5. The network node of any one of Embodiments A1-A4, wherein at least one of the at least one multiplier sequence is generated by a function that is based at least in part on at least one of:

a resource block index, n, the resource block index indicating a resource block on which the CSI-RS signaling is transmitted; and

a code division multiplexing (CDM) group index, s, the CDM group index indicating an orthogonal cover code.

Embodiment A6. The network node of any one of Embodiments A1-A5, wherein, for at least one antenna port in the CSI-RS configuration, a CSI-RS resource is configured with a reference signal sequence that is not generated using the at least one multiplier sequence, while, for at least one other antenna port in the CSI-RS configuration, a CSI-RS resource is configured with a reference signal sequence that is generated using the at least one multiplier sequence.

Embodiment A7. The network node of any one of Embodiments A1-A6, wherein, for at least one antenna port in the CSI-RS configuration, a reference signal sequence is configured to be generated by a pseudo-random sequence generator multiplied by at least one of the at least one multiplier sequence.

Embodiment A8. The network node of any one of Embodiments A1-A7, wherein the CSI feedback includes a precoding matrix indicator (PMI).

Embodiment B 1. A method implemented in a network node, the method comprising:

configuring, a wireless device (WD), with at least one channel state information reference signal (CSI-RS) resource, the configuration indicating at least one multiplier sequence for the at least one CSI-RS resource;

optionally, transmitting CSI-RS signaling on the at least one CSI-RS resource according to the configuration; and/or

optionally, receiving CSI feedback based at least in part on the transmitted CSI-RS signaling.

Embodiment B2. The method of Embodiment B 1, wherein the at least one multiplier sequence is at least one port-specific multiplier sequence.

Embodiment B3. The method of Embodiment B2, wherein the at least one port-specific multiplier sequence corresponds to at least one port-specific multiplier sequence that is different for each antenna port of a code division multiplexing (CDM) group for CSI-RS.

Embodiment B4. The method of any one of Embodiments B 1-B3, wherein the configuration is via radio resource control (RRC) signaling.

Embodiment B5. The method any one of Embodiments B1-B4, wherein at least one of the at least one multiplier sequence is generated by a function that is based at least in part on at least one of:

a resource block index, n, the resource block index indicating a resource block on which the CSI-RS signaling is transmitted; and

a code division multiplexing (CDM) group index, s, the CDM group index indicating an orthogonal cover code.

Embodiment B6. The method any one of Embodiments B1-B5, wherein, for at least one antenna port in the CSI-RS configuration, a CSI-RS resource is configured with a reference signal sequence that is not generated using the at least one multiplier sequence, while, for at least one other antenna port in the CSI-RS configuration, a CSI-RS resource is configured with a reference signal sequence that is generated using the at least one multiplier sequence.

Embodiment B7. The method of any one of Embodiments B 1-B6, wherein, for at least one antenna port in the CSI-RS configuration, a reference signal sequence is configured to be generated by a pseudo-random sequence generator multiplied by at least one of the at least one multiplier sequence.

Embodiment B8. The method of any one of Embodiments B 1-B7, wherein the CSI feedback includes a precoding matrix indicator (PMI).

Embodiment C1. A wireless device (WD) configured to communicate with a network node, the WD configured to, and/or comprising a radio interface and/or processing circuitry configured to:

receive a configuration of at least one channel state information reference signal (CSI-RS) resource, the configuration indicating at least one multiplier sequence for the at least one CSI-RS resource;

optionally, receive CSI-RS signaling on the at least one CSI-RS resource according to the configuration; and/or

optionally, perform a measurement on the received CSI-RS signaling and/or transmit CSI feedback, the CSI feedback based at least in part on the measurement on the received CSI-RS signaling.

Embodiment C2. The wireless device of Embodiment C1, wherein the at least one multiplier sequence is at least one port-specific multiplier sequence.

Embodiment C3. The wireless device of Embodiment C2, wherein the at least one port-specific multiplier sequence corresponds to at least one port-specific multiplier sequence that is different for each antenna port of a code division multiplexing (CDM) group for CSI-RS.

Embodiment C4. The wireless device of any one of Embodiments C1-C3, wherein the configuration is via radio resource control (RRC) signaling.

Embodiment C5. The wireless device of any one of Embodiments C1-C4, wherein at least one of the at least one multiplier sequence is generated by a function that is based at least in part on at least one of:

a resource block index, n, the resource block index indicating a resource block on which the CSI-RS signaling is transmitted; and

a code division multiplexing (CDM) group index, s, the CDM group index indicating an orthogonal cover code.

Embodiment C6. The wireless device of any one of Embodiments C1-C5, wherein, for at least one antenna port in the CSI-RS configuration, a CSI-RS resource is configured with a reference signal sequence that is not generated using the at least one multiplier sequence, while, for at least one other antenna port in the CSI-RS configuration, a CSI-RS resource is configured with a reference signal sequence that is generated using the at least one multiplier sequence.

Embodiment C7. The wireless device of any one of Embodiments C1-C6, wherein, for at least one antenna port in the CSI-RS configuration, a reference signal sequence is configured to be generated by a pseudo-random sequence generator multiplied by at least one of the at least one multiplier sequence.

Embodiment C8. The wireless device of any one of Embodiments C1-C7, wherein the CSI feedback includes a precoding matrix indicator (PMI).

Embodiment D1. A method implemented in a wireless device (WD), the method comprising:

receiving a configuration of at least one channel state information reference signal (CSI-RS) resource, the configuration indicating at least one multiplier sequence for the at least one CSI-RS resource;

optionally, receiving CSI-RS signaling on the at least one CSI-RS resource according to the configuration; and/or

optionally, performing a measurement on the received CSI-RS signaling and/or transmitting CSI feedback, the CSI feedback based at least in part on the measurement on the received CSI-RS signaling.

Embodiment D2. The method of Embodiment D1, wherein the at least one multiplier sequence is at least one port-specific multiplier sequence.

Embodiment D3. The method of Embodiment D2, wherein the at least one port-specific multiplier sequence corresponds to at least one port-specific multiplier sequence that is different for each antenna port of a code division multiplexing (CDM) group for CSI-RS.

Embodiment D4. The method of any one of Embodiments D1-D3, wherein the configuration is via radio resource control (RRC) signaling.

Embodiment D5. The method of any one of Embodiments D1-D4, wherein at least one of the at least one multiplier sequence is generated by a function that is based at least in part on at least one of:

a resource block index, n, the resource block index indicating a resource block on which the CSI-RS signaling is transmitted; and

a code division multiplexing (CDM) group index, s, the CDM group index indicating an orthogonal cover code.

Embodiment D6. The method of any one of Embodiments D1-D5, wherein, for at least one antenna port in the CSI-RS configuration, a CSI-RS resource is configured with a reference signal sequence that is not generated using the at least one multiplier sequence, while, for at least one other antenna port in the CSI-RS configuration, a CSI-RS resource is configured with a reference signal sequence that is generated using the at least one multiplier sequence.

Embodiment D7. The method of any one of Embodiments D1-D6, wherein, for at least one antenna port in the CSI-RS configuration, a reference signal sequence is configured to be generated by a pseudo-random sequence generator multiplied by at least one of the at least one multiplier sequence.

Embodiment D8. The method of any one of Embodiments D1-D7, wherein the CSI feedback includes a precoding matrix indicator (PMI).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a wireless device, WD, the method comprising:
receiving a configuration of at least one channel state information reference signal, CSI-RS, resource, the configuration indicating at least one parameter for at least one modifier for the at least one CSI-RS resource;
the at least one modifier being one of at least one multiplier sequence, at least one CSI-RS port to orthogonal cover code, OCC, index permutation sequence and at least one CSI-RS port to OCC index cyclic shifting;
the configuration indicating a plurality of parameters for a plurality of modifiers;
at least one of the at least one parameter being at least one cyclic shift value for cyclic shifting of the at least one CSI-RS port;
receiving a CSI-RS signaling on the at least one CSI-RS resource according to the configuration; and
performing a measurement on the received CSI-RS signaling and transmitting a CSI feedback, the CSI feedback based at least in part on the measurement on the received CSI-RS signaling.

2. The method of claim 1, wherein the at least one multiplier sequence comprises at least one port-specific multiplier sequence.

3. The method of claim 2, wherein the at least one port-specific multiplier sequence comprises at least one port-specific multiplier sequence that is different for each antenna port of a code division multiplexing, CDM, group.

4. (canceled)

5. The method of claim 1, wherein at least one of the at least one multiplier sequence is based at least in part on at least one of a resource block index, n, the resource block index indicating a resource block on which the CSI-RS signaling is transmitted.

6. The method of claim 1, wherein each of the at least one multiplier sequence varies across a plurality of resource blocks, RBs.

7. The method of claim 1, wherein at least one of the at least one multiplier sequence is based at least in part on a code division multiplexing, CDM, group index, s, the CDM group index indicating an orthogonal cover code.

8.-10. (canceled)

11. A method implemented in a network node, the method comprising:
transmitting a configuration of at least one channel state information reference signal, CSI-RS, resource, the configuration indicating at least one parameter for at least one modifier for the at least one CSI-RS resource;
the at least one modifier being one of at least one multiplier sequence, at least one CSI-RS port to orthogonal cover code, OCC, index permutation sequence and at least one CSI-RS port to OCC index cyclic shifting;
the configuration indicating a plurality of parameters for a plurality of modifiers;
at least one of the at least one parameter being used as a seed to generate the at least one multiplier sequence; and
at least one of the at least one parameter being at least one cyclic shift value for cyclic shifting of the at least one CSI-RS port;
transmitting a CSI-RS signaling on the at least one CSI-RS resource according to the configuration; and
receiving a CSI feedback based at least in part on the transmitted CSI-RS signaling.

12. The method of claim 11, wherein the at least one multiplier sequence comprises at least one port-specific multiplier sequence.

13. The method of claim 12, wherein the at least one port-specific multiplier sequence comprises at least one port-specific multiplier sequence that is different for each antenna port of a code division multiplexing, CDM, group.

14. (canceled)

15. The method of claim 11, wherein at least one of the at least one multiplier sequence is based at least in part on at least one of a resource block index, n, the resource block index indicating a resource block on which the CSI-RS signaling is transmitted.

16. The method of claim 11, wherein each of the at least one multiplier sequence varies across a plurality of resource blocks, RBs.

17. The method of claim 11, wherein at least one of the at least one multiplier sequence is based at least in part on a code division multiplexing, CDM, group index, s, the CDM group index indicating an orthogonal cover code.

18.-20. (canceled)

21. A wireless device, WD, configured to communicate with a network node, the WD comprising processing circuitry, the processing circuitry configured to cause the WD to:
receive a configuration of at least one channel state information reference signal, CSI-RS, resource, the configuration indicating at least one parameter for at least one modifier for the at least one CSI-RS resource;
the at least one modifier being one of at least one multiplier sequence, at least one CSI-RS port to orthogonal cover code, OCC, index permutation sequence and at least one CSI-RS port to OCC index cyclic shifting;
the configuration indicating a plurality of parameters for a plurality of modifiers;
at least one of the at least one parameter being used as a seed to generate the at least one multiplier sequence; and
at least one of the at least one parameter being at least one cyclic shift value for cyclic shifting of the at least one CSI-RS port; and
perform a measurement on the received CSI-RS signaling and transmit a CSI feedback, the CSI feedback based at least in part on the measurement on the received CSI-RS signaling.

22. The WD of claim 21, wherein the at least one multiplier sequence comprises at least one port-specific multiplier sequence.

23.-42. (canceled)
